(19) United States
(12) Patent Application Publication
(10) Pub. No.: US 2023/0049394 A1
(43) Pub. Date: Feb. 16, 2023

(54) FIELD-WIDE CONTINUOUS GAS LIFT OPTIMIZATION UNDER RESOURCE AND OPERATIONAL CONSTRAINTS

(71) Applicant: Schlumberger Technology Corporation, Sugar Land, TX (US)

(72) Inventors: Kashif Rashid, Wayland, MA (US); Sandeep Verma, Acton, MA (US)

(21) Appl. No.: 17/759,052

(22) PCT Filed: Jan. 19, 2021
(86) PCT No.: PCT/US2021/013975

§ 371 Date: Jul. 19, 2022

Related U.S. Application Data
(60) Provisional application No. 62/963,326, filed on Jan. 20, 2020.

(51) Int. Cl. E21B 43/12

(52) U.S. Cl. CPC E21B 43/123; E21B 2200/20

(57) ABSTRACT

A method can include receiving production fluid flow rate data from a well in a field that includes a plurality of wells; generating a gas lift profile for the well using the production fluid flow rate data; solving a system of equations representing at least two gas lift profiles for at least two of the plurality of wells to generate results; and issuing an instruction based at least in part on the results to control gas lift for production of fluid by the well.

### RELATED APPLICATIONS

This application claims the benefit of and priority to U.S. Provisional Application Ser. No. 62/963326, filed Jan. 20, 2021, which is incorporated by reference herein.

### FIELD

The present disclosure relates to artificial lift of produced fluids in one or more wells that traverse a hydrocarbon-bearing formation, and, more particularly to control of gas lift in oil and gas fields.

### BACKGROUND

The rapid development and evolution of unconventional reservoirs in the United States has led to enormous growth in drilling, completion and production from these basins. Unlike conventional reservoirs, however, the production from these wells declines rapidly and often, in a few years, the reservoir pressure drops below what is required to naturally produce oil to the surface. Primary production of a reservoir refers to the phase when the reservoir pressure is adequate to lift the oil to the surface. Obviously, for this to occur, the reservoir pressure has to be higher than the pressure exerted by a column of oil in the wellbore (P_{H}). As the pressure declines to less than PH, artificial lift techniques are generally deployed to recover additional oil.

In depleted reservoirs, when the reservoir pressure drops below the pressure required to produce the oil to the surface, technologies such as gas lift, electrical submersible pumps and rod pumps may be used (based on reservoir characteristics) to boost the oil pressure for production. Continuous gas lift is a reliable artificial lift technique that is widely used in unconventional reservoirs. The allocation of available lift gas to many wells in a field to boost production is a classic oilfield optimization challenge.

### SUMMARY

A method can include receiving production fluid flow rate data from a well in a field that includes a plurality of wells; generating a gas lift profile for the well using the production fluid flow rate data; solving a system of equations representing at least two gas lift profiles for at least two of the plurality of wells to generate results; and issuing an instruction based at least in part on the results to control gas lift for production of fluid by the well. A system can include one or more processors; memory accessible to at least one of the one or more processors; processor-executable instructions stored in the memory and executable to instruct the system to: receive production fluid flow rate data from a well in a field that includes a plurality of wells; generate a gas lift profile for the well using the production fluid flow rate data; solve a system of equations representing at least two gas lift profiles for at least two of the plurality of wells to generate results; and issue an instruction based at least in part on the results to control gas lift for production of fluid by the well. One or more non-transitory computer-readable storage media can include computer-executable instructions executable to instruct a computing system to: receive production fluid flow rate data from a well in a field that includes a plurality of wells; generate a gas lift profile for the well using the production fluid flow rate data; solve a system of equations representing at least two gas lift profiles for at least two of the plurality of wells to generate results; and issue an instruction based at least in part on the results to control gas lift for production of fluid by the well

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and an example of a method;

FIG. 2 illustrates an example of a system;

FIG. 3 illustrates an example of a gas lift valve;

FIGS. 4A and 4B illustrate the gas lift valve of FIG. 3;

FIG. 5 illustrates an example of a system;

FIG. 6 illustrates an example of a system;

FIG. 7 illustrates an example of a method;

FIG. 8 illustrates an example of a plot;

FIG. 9 illustrates an example of a plot;

FIG. 10 illustrates an example of a plot;

FIG. 11 illustrates an example of a plot;

FIG. 12 illustrates an example of a plot;

FIG. 13 illustrates an example of a plot;

FIG. 14 illustrates an example of a plot;

FIG. 15 illustrates an example of a plot;

FIG. 16 illustrates an example of a plot;

FIG. 17 illustrates an example of a plot;

FIG. 18 illustrates an example of a plot;

FIG. 19 illustrates an example of a plot;

FIG. 20 illustrates an example of a plot;

FIG. 21 illustrates an example of a plot;

FIG. 22 illustrates an example of a plot;

FIG. 23 illustrates an example of a system;

FIG. 24 illustrates an example of a system; and

FIG. 25 illustrates an example of a computing system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Gas lift is a process where, for example, gas may be injected from an annulus into tubing. An annulus, as applied to an oil well or other well for recovering a subsurface resource may refer to a space, lumen, or void between piping, tubing or casing and the piping, tubing, or casing immediately surrounding it, for example, at a greater radius.

As an example, injected gas may aerate well fluid in production tubing in a manner that “lightens” the well fluid such that the fluid can flow more readily to a surface location. As an example, one or more gas lift valves may be configured to control flow of gas during an intermittent flow or a continuous flow gas lift operation. As an example, a gas lift valve may operate based at least in part on a differential pressure control that can actuate a valve mechanism of the gas lift valve.

As gas lift valve may include a so-called hydrostatic pressure chamber that, for example, may be charged with a desired pressure of gas (e.g., nitrogen, etc.). As an example, an injection-pressure-operated (IPO) gas lift valve or an unloading valve can be configured so that an upper valve in a production string opens before a lower valve in the production string opens.

As an example, a gas lift valve may be configured, for example, in conjunction with a mandrel, for placement and/or retrieval of the gas lift valve using a tool. For example, consider a side pocket mandrel that is shaped to allow for installation of one or more components at least partially in a side pocket or side pockets where a production flow path through the side pocket mandrel may provide for access to a wellbore and completion components located below the side pocket mandrel. As an example, a side pocket mandrel can include a main axis and a pocket axis where the pocket axis is offset a radial distance from the main axis. In such an example, the main axis may be aligned with production tubing, for example, above and/or below the side pocket mandrel.

As an example, a tool may include an axial length from which a portion of the tool may be kicked-over (e.g., to a kicked-over position). In such an example, the tool may include a region that can carry a component such as a gas lift valve. An installation process may include inserting a length of the kickover tool into a side pocket mandrel (e.g., along a main axis) and kicking over a portion of the tool that carries a component toward the side pocket of the mandrel to thereby facilitate installation of the component in the side pocket. A removal process may operate in a similar manner, however, where the portion of the tool is kicked-over to facilitate latching to a component in a side pocket of a side pocket mandrel.

As an example, artificial lift may employ one or more types of gas lift techniques and/or technologies. In various instances, one or more valves may be utilized to control gas flow and/or gas pressure. As an example, a valve may be a surface valve (e.g., a surface gas choke valve, etc.), a valve may be a downhole valve (e.g., a mandrel valve, a packer valve, a standing valve, etc.). Various examples of mandrel valves that may be disposed in a pocket of a mandrel are given for illustrative purposes as to some examples of physical phenomena, equipment, techniques, technologies, etc., that may be utilized in employing gas lift as an artificial lift strategy for production of reservoir fluid (e.g., oil, etc.).

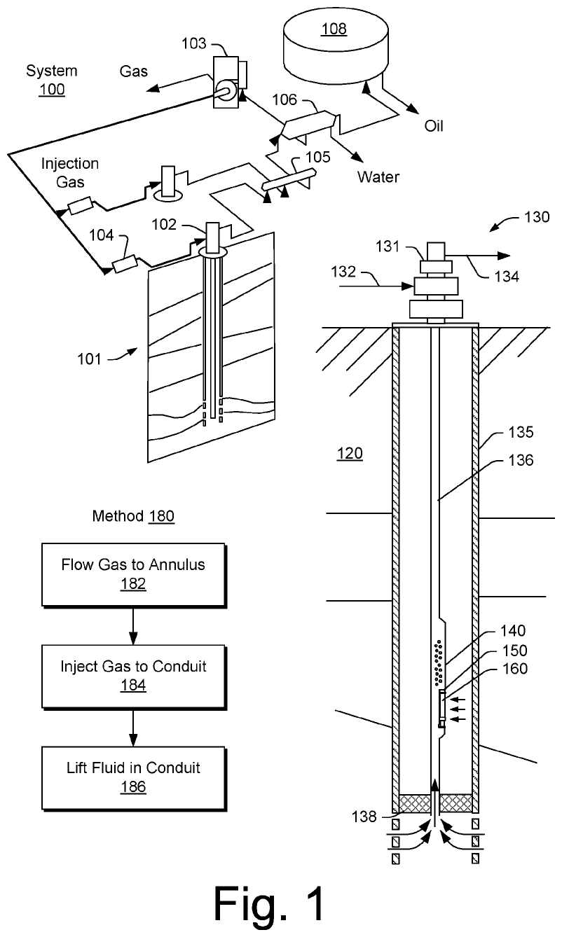

FIG. 1 shows an example of a system 100, an example of a geologic environment 120 that includes equipment and an example of a method 180. The system 100 includes a subterranean formation 101 with a well 102. Injection gas is provided to the well 102 via a compressor 103 and a regulator 104. The injection gas can assist with lifting fluid that flows from the subterranean formation 101 to the well 102. The lifted fluid, including injected gas, may flow to a manifold 105, for example, where fluid from a number of wells may be combined. As shown in the example of FIG. 1, the manifold 105 is operatively coupled to a separator 106, which may separate components of the fluid. For example, the separator 106 may separate oil, water and gas components as substantially separate phases of a multiphase fluid. In such an example, oil may be directed to an oil storage facility 108 while gas may be directed to the compressor 103, for example, for re-injection, storage and/or transport to another location. As an example, water may be directed to a water discharge, a water storage facility, etc.

As shown in FIG. 1, the geologic environment 120 is fitted with well equipment 130, which includes a well-head 131 (e.g., a Christmas tree, etc.), an inlet conduit 132 for flow of compressed gas, an outlet conduit 134 for flow of produced fluid, a casing 135, a production conduit 136, and a packer 138 that forms a seal between the casing 135 and the production conduit 136. As shown, fluid may enter the casing 135 (e.g., via perforations) and then enter a lumen of the production conduit 136, for example, due to a pressure differential between the fluid in the subterranean geologic environment 120 and the lumen of the production conduit 136 at an opening of the production conduit 136. Where the inlet conduit 132 for flow of compressed gas is used to flow gas to the annular space between the casing 135 and the production conduit 136, a mandrel 140 operatively coupled to the production conduit 136 that includes a pocket 150 that seats a gas lift valve 160 that may regulate the introduction of the compressed gas into the lumen of the production conduit 136. In such an example, the compressed gas introduced may facilitate flow of fluid upwardly to the well-head 131 (e.g., opposite a direction of gravity) where the fluid may be directed away from the well-head 131 via the outlet conduit 134.

As shown in FIG. 1, the method 180 can include a flow block 182 for flowing gas to an annulus (e.g., or, more generally, a space exterior to a production conduit fitted with a gas lift valve), an injection block 184 for injecting gas from the annulus into a production conduit via a gas lift valve or gas lift valves and a lift block 186 for lifting fluid in the production conduit due in part to buoyancy imparted by the injected gas.

As an example, where a gas lift valve includes one or more actuators (e.g., one or more shape memory material actuators, etc.), such actuators may optionally be utilized to control, at least in part, operation of a gas lift valve (e.g., one or more valve members of a gas lift valve). As an example, surface equipment can include one or more control lines that may be operatively coupled to a gas lift valve or gas lift valves, for example, where a gas lift valve may respond to a control signal or signals via the one or more control lines. As an example, surface equipment can include one or more power lines that may be operatively coupled to a gas lift valve or gas lift valves, for example, where a gas lift valve may respond to power delivered via the one or more power lines. As an example, a system can include one or more control lines and one or more power lines where, for example, a line may be a control line, a power line or a control and power line.

As an example, a production process may optionally utilize one or more fluid pumps such as, for example, an electric submersible pump (e.g., consider a centrifugal pump, a rod pump, etc.). As an example, a production process may implement one or more so-called “artificial lift” technologies. An artificial lift technology may operate by adding energy to fluid, for example, to initiate, enhance, etc. production of fluid.

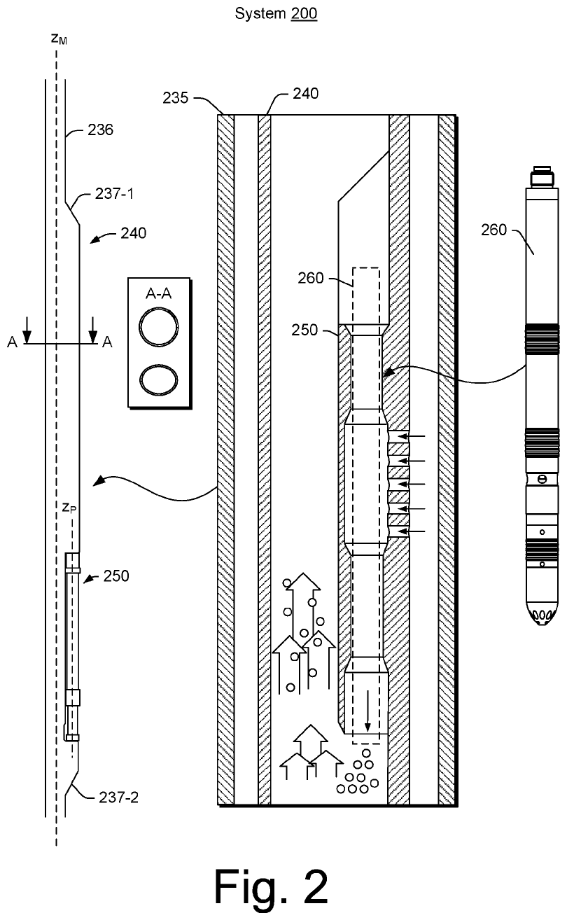

FIG. 2 shows an example of a system 200 that includes a casing 235, a production conduit 236 and a mandrel 240 that includes a pocket 250 that seats a gas lift valve 260. As shown, the mandrel 240 can include a main longitudinal axis (z_{M}) and a side pocket longitudinal axis (z_{P}) that is offset a radial distance from the main longitudinal axis (z_{M}). In the example of FIG. 2, the axes (z_{M} and z_{P}) are shown as being substantially parallel such that a bore of the pocket 250 is parallel to a lumen of the mandrel 240. Also shown in FIG. 2 are two examples of cross-sectional profiles for the mandrel 240, for example, along a line A-A. As shown, a mandrel may include a circular cross-sectional profile or another shaped profile such as, for example, an oval profile.

As an example, a completion may include multiple instances of the mandrel 240, for example, where each pocket of each instance may include a gas lift valve where, for example, one or more of the gas lift valves may differ in one or more characteristics from one or more other of the gas lift valves (e.g., pressure settings, etc.).

As shown in the example of FIG. 2, the mandrel 240 can include one or more openings that provide for fluid communication with fluid in an annulus (e.g., gas and/or other fluid), defined by an outer surface of the mandrel 240 and an inner surface of the casing 235, via a gas lift valve 260 disposed in the pocket 250. For example, the gas lift valve 260 may be disposed in the pocket 250 where a portion of the gas lift valve 260 is in fluid communication with an annulus (e.g., with casing fluid) and where a portion of the gas lift valve 260 is in fluid communication with a lumen (e.g., with tubing fluid). In such an example, fluid may flow from the annulus to the lumen (e.g., bore) to assist with lift of fluid in the lumen or, for example, fluid may flow from the lumen to the annulus. The pocket 250 may include an opening that may be oriented downhole and one or more openings that may be oriented in a pocket wall, for example, directed radially to a lumen space. As an example, the pocket 250 may include a production conduit lumen side opening (e.g., an axial opening) for placement, retrieval, replacement, adjustment, etc. of a gas lift valve. For example, through use of a tool, the gas lift valve 260 may be accessed. As an example, where a gas lift valve includes circuitry such as a battery or batteries, a tool may optionally provide for charging and/or replacement of a battery or batteries.

In the example of FIG. 2, gas is illustrated as entering from the annulus to the gas lift valve 260 as disposed in the pocket 250. Such gas can exit at a downhole end of the gas lift valve 260 where the gas can assist in lifting fluid in the lumen of the mandrel 240 (e.g., as supplied via a bore of production tubing, etc.).

As an example, a side pocket mandrel may be configured with particular dimensions, for example, according to one or more dimensions of commercially available equipment. As an example, a side pocket mandrel may be defined in part by a tubing dimension (e.g., tubing size). For example, consider tubing sizes of about 2.375 in (e.g., about 60 mm), of about 2.875 in (e.g., about 73 mm) and of about 3.5 in (e.g., about 89 mm). As to types of valves that may be suitable for installation in a side pocket mandrel, consider dummy valves, shear orifice valves, circulating valves, chemical injection valves and waterflood flow regulator valves. As an example, a side pocket may include a bore configured for receipt of a device that includes an outer diameter of about 1 in (e.g., about 25 mm), or about 1.5 in. (e.g., about 37 mm) or more. As mentioned, a running tool, a pulling tool, a kickover tool, etc. may be used for purposes of installation, retrieval, adjustment, etc. of a device with respect to a side pocket. As an example, a tool may be positionable via a slickline technique.

As an example, a side pocket mandrel may include a circular and/or an oval cross-sectional profile (e.g., or other shaped profile). As an example, a side pocket mandrel may include an exhaust port (e.g., at a downhole end of a side pocket).

As an example, a mandrel may be fit with a gas lift valve that may be, for example, a valve according to one or more specifications such as an injection pressure-operated (IPO) valve specification. As an example, a positive-sealing check valve may be used such as a valve qualified to meet API-19G1 and G2 industry standards and pressure barrier qualifications. For example, with a test pressure rating of about 10,000 psi (e.g., about 69,000 kPa), a valve may form a metal-to-metal barrier between production tubing and a casing annulus that may help to avoid undesired communication (e.g., or reverse flow) and to help mitigate risks associated with gas lift valve check systems.

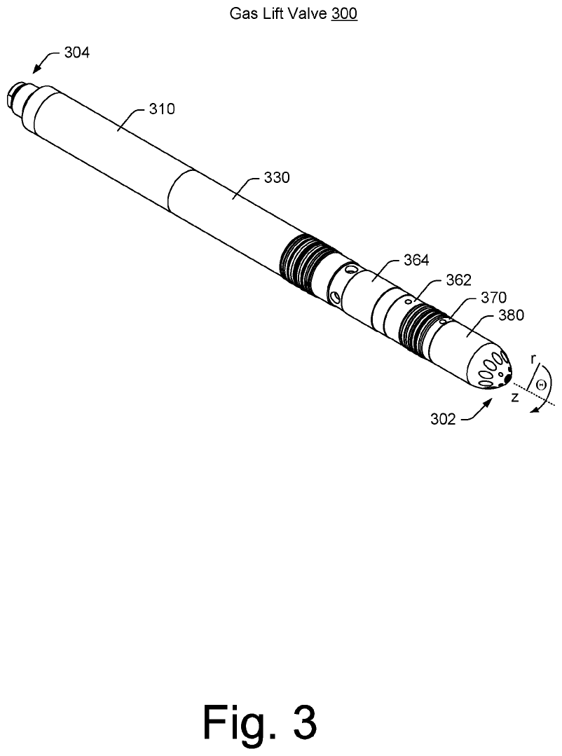

FIG. 3 shows an example of a gas lift valve 300 that includes a gas outlet end 302, a tool end 304, a control gas chamber section 310, a bellows valve mechanism section 330, a coupling 362, a gas inlet section 364, a coupling 370 and a gas outlet section 380. Various features of the gas lift valve 300 may be described with respect to a cylindrical coordinate system (e.g., r, z, Θ0) where, for example, a z-axis represents a longitudinal axis of the gas lift valve 300, a r-axis represents a distance from the z-axis (e.g., radially outwardly) and an azimuthal angle (Θ) represents an azimuthal position of a feature, for example, with respect to a feature that may be deemed to be at 0 degrees (e.g., a reference feature such as an opening, etc.).

In the example of FIG. 3, the gas lift valve 300 can include a plurality of seal elements, for example, to seal against a bore of a mandrel in which at least a portion of the gas lift valve 300 may be disposed. As an example, a seal element or seal elements may act to form a seal between an outer surface of a gas lift valve and an inner surface of a bore of a mandrel where such a seal may be disposed between a gas inlet opening and a gas outlet opening of the gas lift valve. As an example, seal elements may be ring shaped and, for example, at least in part seated in one or more annular grooves of an outer surface of a gas lift valve. As an example, a gas lift valve can include a plurality of internal seal elements.

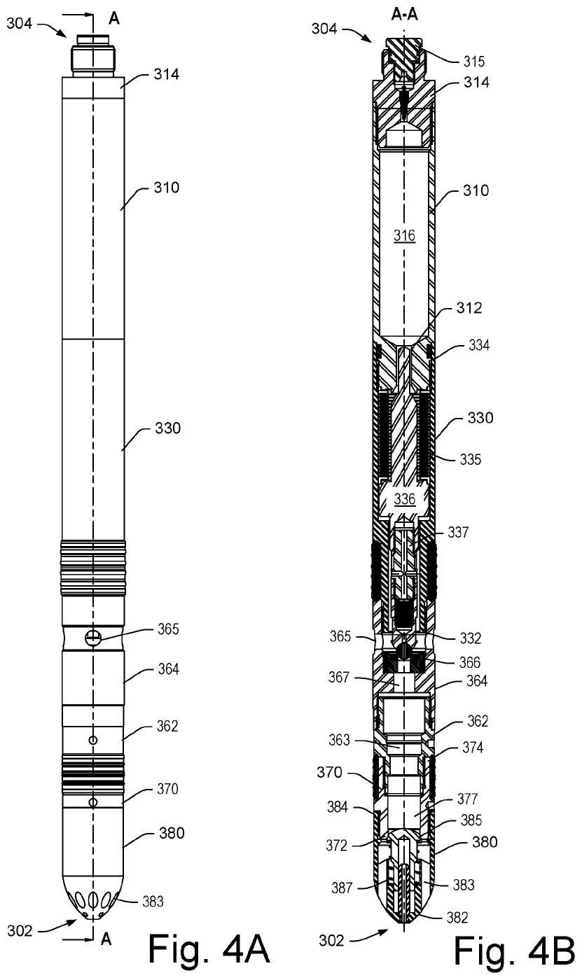

FIG. 4A shows a side view of the gas lift valve 300 and FIG. 4B shows a cutaway view of the gas lift valve 300 along a line A-A. As shown in FIG. 4A, the gas inlet section 364 includes at least one opening 365 as a gas inlet (see, e.g., the arrangement of FIG. 2) and the gas outlet section 380 includes at least one opening 383 as a gas outlet.

FIG. 4B shows the control gas chamber section 310 as including a piston bore 312 and a plug 314 at opposing ends of a gas chamber 316, which may be charged with gas such as nitrogen. In the example of FIG. 4B, a seal plug 315 may be utilized to seal a passage in the plug 314, for example, after charging the gas chamber 316 to a desired gas pressure.

FIG. 4B shows the bellows valve mechanism section 330 as including opposing ends 332 and 334, a bellows 335, a piston 336 and a valve member 337. In the example of FIG. 4B, the bellows 335 may be sealed with respect to the bellows 335 and the chamber 316. In such an example, the one or more openings 365 of the gas inlet section 364 can communicate gas pressure that can act upon the valve member 337. In such an example, where the pressure is sufficiently high (e.g., with respect to pressure in the chamber 316), force exerted may cause the valve member 337 and the piston 336 to translate toward the chamber 316. In such an example, the valve member 337 may retract from a valve seat 366 that is supported by the gas inlet section 364. As shown, the valve seat 366 is annular such that an opening defined thereby can allow for flow of gas to a bore 367 of the gas inlet section 364.

In the example of FIG. 4B, the coupling 362 includes a bore 363 that is in fluid communication with the bore 367 and that is in fluid communication with a bore 377 of the coupling 370 such that gas pressure can act upon a check valve member 385 supported by the gas outlet section 380, which may be seated against an end 372 of the coupling 370, which has an opposing end 374. For example, the check valve member 385 may include a translatable dome shape that can seat against an annular check valve seat defined by the end 372 of the coupling 370.

In the example of FIG. 4B, the check valve member 385 can be biased by a biasing member 387, which may be, for example, a spring. Where gas pressure in the bore 377 of the coupling 370 is sufficiently high, force acting on the check valve member 385 may cause compression of the biasing member 387 and translation of the check valve member 385 downwardly away from the gas inlet section 364 such that the one or more openings 365 of the gas inlet section 364 become in fluid communication with the one or more openings 383 of the gas outlet section 380.

As an example, the check valve member 385 may be referred to as a dart. As an example, the check valve member 385 may be considered to be a low pressure valve member; whereas, the valve member 337 may be considered to be a high pressure valve member. As an example, a valve member can include a ball that can be seated in a valve seat to plug an opening in the valve seat.

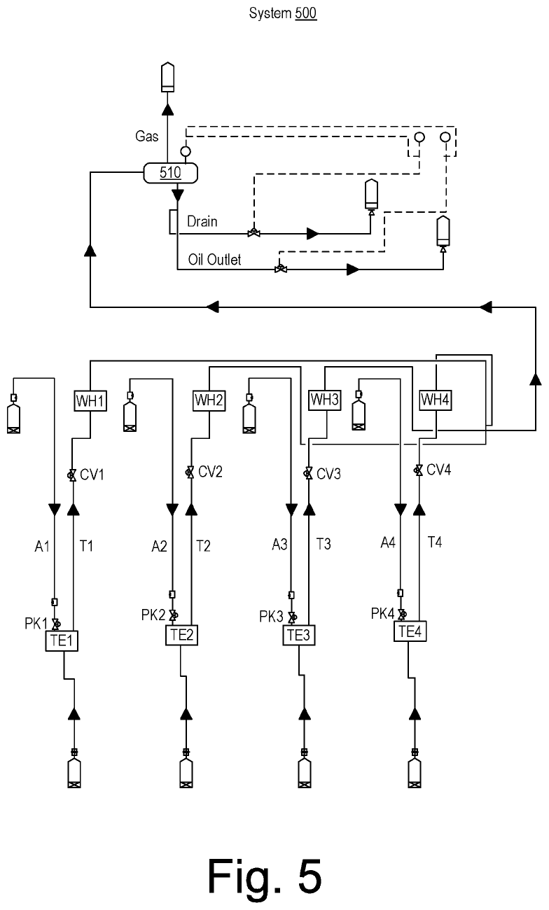

FIG. 5 shows an example of a system 500 that includes a separator 510 that can separate gas from fluid produced from a plurality of wells, indicated via wellheads WH1, WH2, WH3 and WH4, where each well includes a choke valve CV1, CV2, CV3 and CV4, an annulus A1, A2, A3 and A4, a production tubing T1, T2, T3 and T4 with a tubing end TE1, TE2, TE3 and TE4 along with a packer PK1, PK2, PK3 and PK4. As shown, gas can be injected into each of the wells using gas that can include gas separated from fluid (e.g., reservoir fluid) produced from the plurality of wells and/or one or more other sources. In the example of FIG. 5, dashed lines indicate some examples of control features; noting that control features may be included for various equipment of one or more of the wells (e.g., choke valves, packers, gas lift valves, etc.). As an example, the system 500 of FIG. 5 may be implemented with one or more features of the system 100 of FIG. 1. As indicated in FIG. 1, the separator 106 may separate oil, water and gas components as substantially separate phases of a multiphase fluid. In the example of FIG. 5, the separator 510 may be utilized for separation of one or more components of a multiphase fluid.

As an example, a simulation model can include digital representations of various system features. For example, consider a simulation model that can include digital representations various gas lift wells of along with flowlines and one or more separators where the simulation model can capture the dynamics associated with gas injection and fluid production in a network of wells of varying design (e.g., dimension, trajectory, completion, fluid type, etc.).

The systems and methods described herein can operate to control operations of a gas lift system that lifts produced fluids from one or more production wells, such as those found in oil and gas fields. Such fields can include one or more production wells that provide access to the reservoir fluids underground such as, for example, the production wells of the system 500 of FIG. 5.

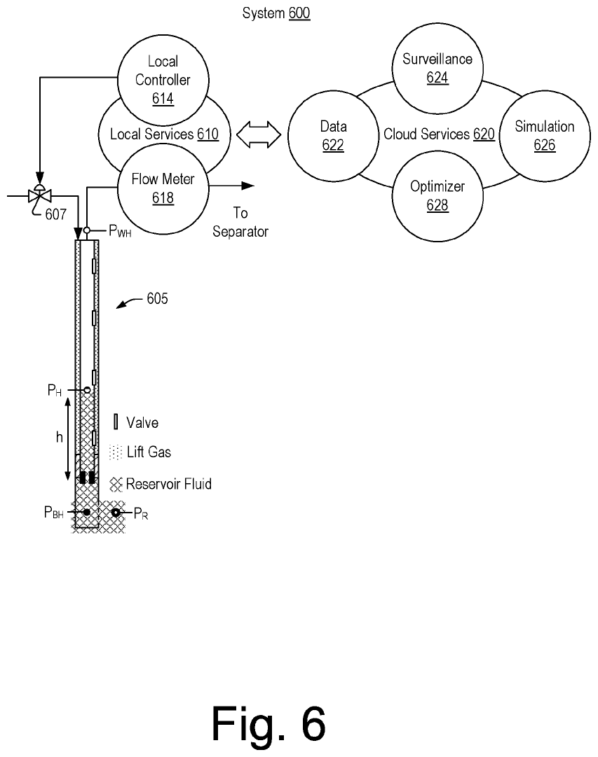

FIG. 6 shows an example of a system 600 that includes well equipment 605, local services 610 operatively coupled to a local controller 614 and a flow meter 618 and cloud-based services 620 that can provide for one or more of data storage and handling 622, surveillance 624, simulation 626 and/or optimization 628.

In the example of FIG. 6, the well equipment 605 can include production tubing and an annular space where, for example, one or more valves may be included that can control flow of fluid from and/or to the annular space. For example, consider one or more gas lift valves that may be disposed in one or more mandrels, pockets, etc. In such an example, a gas lift valve may be controllable in an active manner (e.g., via one or more signals) and/or a passive manner (e.g., consider pre-set as to one or more pressures prior to installation). As an example, a surface valve or a choke valve 607 (e.g., “CV_{G}”) can be used to control annular gas pressure, for example, via one or more control signals issued by the local controller 614, which can be operatively coupled to an actuator. As an example, the well equipment 605 can include one or more surface valves such as, for example, a gas choke valve and a reservoir fluid choke valve. In such an example, a gas choke valve may control annulus flow and/or pressure and a reservoir fluid choke valve may control production tubing flow and/or pressure.

FIG. 6 also shows various examples of pressure, including reservoir pressure (P_{R}), bottom hole pressure (P_{BH}), wellhead pressure (P_{WH}) and column or head pressure (P_{H}), which can correspond to a vertical dimension (h) as can be defined with respect to a direction of the acceleration of gravity. As explained, primary production of a reservoir can refer to a stage where the reservoir pressure (P_{R}) by itself is adequate to lift the reservoir fluid (e.g., oil) to the surface (e.g., the wellhead). Given fluid dynamics, for primary production to occur, the reservoir pressure (P_{R}) is to be higher than the pressure exerted by the column of reservoir fluid (e.g., oil) in the production tubing (P_{H}). As the reservoir pressure (P_{R}) can decline during primary production to a value that is below the column pressure (P_{H}), one or more artificial lift techniques may be employed to recover additional reservoir fluid (e.g., oil).

As an example, in a gas lift system, the local controller 614 can provide for managing a desired set point for the well. For example, injected lift gas can be utilized to reduce density of a fluid column enabling hydrocarbons to be produced at surface. In such an example, the cloud-based services 620 may provide for instantiation of a global controller that can provide for managing set points over multiple wells, for example, subject to available lift-gas and/or other stipulated constraints.

In the example of FIG. 6, a gas/oil separator may be installed downhole as part of the well equipment 605 where such a separator can provide for the production of oil and gas separately. As an example, such a separator can be an active device, a passive device, a level sensor that allows separation to occur under the influence of gravity, etc. Under primary production, which can be defined under conditions where reservoir pressure P_{R}>P_{H}, oil can be produced via production tubing while gas can be vented via an annular space or, for example, produced in conjunction with the oil. Where gas is produced in conjunction with oil, a gas/oil separator can be installed at the surface (see, e.g., the separator 510 of the system 500 of FIG. 5). In the system 600, the flow meter 618 can be installed at the surface to measure the flow rate of the fluid produced from well as a function of time.

As explained, gas lift can be considered a secondary (or tertiary) production artificial lift technology suitable for use in various scenarios (e.g., depleted oil wells, etc.). As explained, gas utilized for lift may be field (or natural) gas, or in some instances, some other gas such as nitrogen. As an example, when reservoir pressure drops just below a level sufficient to produce reservoir fluid to the surface, mixing some amount of gas with a reservoir fluid column (e.g., an oil column) can be sufficient to reduce density of the reservoir fluid and hence the pressure exerted by the column of this gas-reservoir fluid mixture to allow for production. As an example, an approach to gas lift can be staged. For example, consider an initial stage and one or more subsequent stages. As to an initial stage, consider utilization of a continuous gas lift where gas is substantially constantly injected into reservoir fluid at one or more locations along production tubing (e.g., and/or casing in certain instances). As explained, technologies such as pocket mandrel technology may be utilized where one or more valves are disposed at least in part in one or more pockets. In various instances, a mandrel can include multiple pockets that can be arranged at a common axial position and/or at varied axial positions. Where multiple pockets exist and/or where various mandrels are utilized, valves may be selected for particular lift regimes (e.g., selected operational parameters, etc.).

After producing a well for a time period, for example, in an initial stage, reservoir pressure can decrease such that it may be characterized as being depleted where some more and even continuous injection of gas into the a column is not sufficient to lower a bottom hole pressure enough for the well to flow. When such conditions exist, a transition may be made from a continuous stage to an intermittent stage. For example, rather than utilizing substantially continuous gas lift, gas lift can be intermittent where it occurs intermittently (e.g., period of time that can be separated by non-gas lift period in excess of a minute, etc.).

In intermittent gas lift, a producing conduit (e.g., tubing or casing) can be filled with gas such a well flows to fill a portion of it. In such an example, once a column is established to a certain height, a slug of gas can be introduced at a sufficiently high velocity to drive the oil column out, for example, to a separator.

As an example, a method can include optimizing gas lift. For example, consider a method that can control equipment such that one or more parameters during one or more stages of gas lift can be adjusted, transitioned, etc., in a manner that aims to provide for more efficient utilization of gas, more efficient production, more timely production, etc. In such an example, the method may consider conditions and/or equipment at a single well, multiple wells and/or at surface (e.g., conduits, valves, separators, compressors, etc.).

As to an optimization approach, one or more objective functions may be utilized. For example, consider an objective function that aims to provide for maximal production of oil from one or more wells in one or more fields. As an example, one or more objective functions can be subject to certain constraints, for example, consider one or more constraints as to as gas availability, which may be present and/or future gas availability.

As explained, an optimization approach may be applicable to field-wide gas lift optimization under operational constraints. As an example, a system can include one or more wells that can benefit from lift-gas to sustain acceptable production levels. As available injection gas may be a limited resource, an optimal allocation procedure can be demonstrated under operating constraints imposed by well or field capacity. As an example, a method can include employing local sensitivity information to construct representative approximating models in a local trust region. In such an example, a resulting system can be optimized using an interior point method that helps to ensure solution path feasibility. For example, consider an approach that aims to ensure that evaluated points are constraint feasible. As an example, a solver can be implemented utilizing one or more computational frameworks that can solve a nonlinear inequality constrained system that can set a new operating point (e.g., an updated operating point, etc.). In various instances, stabilization can be considered such that, for example, after a suitable period for stabilization, a process can be repeated to ensure optimal resource allocation and field operation under stipulated constraints. In such an example, the stabilization period may be one or more of pre-defined, simulation-based, measurement-based, etc. Such an approach to optimization may be applied to an operating field using real-time data and/or to a representative simulation. In various instances, simulation may be used to assist application of a scheme to a real field. As an example, an optimization methodology can utilize real time input data, such as injection gas flow rate (e.g., determined by a flow meter in a flowline that supplies injected gas to a respective well, etc.), oil production rate (e.g., determined by a flow meter in a flowline that carries produced fluids or oil alone from a respective well, etc.), and/or one or more additional variables based on one or more desired objectives. As an example, an optimization methodology can generate real-time outputs, such as, for example, one or more set points for injection gas flow rate and, for example, one or more set points for one or more other control variables (e.g., if present and/or if desired).

In various example embodiments, an optimization methodology can provide an optimal allocation of lift-gas under given operating constraints at well or field level. Such an optimization methodology can use production data to construct representative models of lift performance capability of one or more individual wells, and subsequently, a system can be optimized to give a new operating point that is constraint feasible. In such an example, the solution to the nonlinear constrained problem can indicate a new field operating point, and after a suitable period for stabilization, such a process can be repeated. In such an example, at each increment, optimal resource allocation and field operation may be improved under various stipulated constraints (e.g., as specified, etc.).

As an example, an optimization methodology can be applied to an existing field, for example, using data provisioned from real-time multi-phase flow meters, which may be available, for example, at a wellhead and/or downstream of a separator. In such an example, production data acquisition frequency may vary (e.g., from seconds to minutes), where, based on data availability, data can be used to infer production rates of one or more of oil, water and gas phases at a given operating point. As an example, a local programmable controller can be configured to receive production data, and/or information derived therefrom, as representative input, and utilize an optimization methodology to generate a new output signal to set one or more gas injection rates, which may be for one or more individual wells across a field to ensure optimal allocation under stipulated constraints to maximize a target objective. As an example, a controlled approach to gas lift may account for wells that include various branches (e.g., legs, etc.).

As mentioned, a method can utilize simulation for one or more purposes. For example, consider simulation as part of a control scheme, an optimization scheme, a verification scheme, a safety scheme, etc. As an example, a high-fidelity dynamic simulator such as, for example, the OLGA simulator may be utilized. For example, the system 500 of FIG. 5 can be utilized to formulate a simulation model that can be utilized by the OLGA simulator.

The OLGA dynamic multiphase flow simulator can be implemented to model time-dependent behaviors, or transient flow, which may help to maximize production potential. Transient modeling can be utilized for feasibility studies and field development design. Dynamic simulation may be suitable for deepwater and may be used in both offshore and onshore developments, for example, to investigate transient behavior in pipelines and wellbores.

Transient simulation with the OLGA simulator can provide an added dimension to steady-state analyses by predicting system dynamics such as time-varying changes in flow rates, fluid compositions, temperature, solids deposition and operational changes.

The OLGA simulator can be implemented for wellbore dynamics, well completions, pipeline systems, etc., with various types of equipment. The OLGA simulator may be utilized for various types of simulations such as, for example, liquids handling, sizing separators and slug catchers, managing solids, simulating operational procedures including start-up, shut-down, and pigging, modeling for contingency planning, and assessing environmental risk in complex deepwater drilling environments.

As an example, one or more simulators may be utilized, which may optionally be coupled. For example, consider the PIPESIM simulator, which provides features for steady-state flow assurance workflows, for example, for front-end system design and production operations. The PIPESIM simulator provides flow assurance capabilities that can help provide for safe and effective fluid transport, for example, consider one or more of sizing of facilities, pipelines, and lift systems, to ensuring effective liquids and solids management, to well and pipeline integrity. As to dynamic analyses, a PIPESIM-to-OLGA converter tool can provide for expedited utilization of one or more models (e.g., conversion from PIPESIM simulator model to OLGA simulator model, etc.). As an example, simulation may take into account various types of phenomena such as, for example, one or more of heat transfer, multiphase flow, and fluid behavior, which may provide for suitable data quality and consistency between steady-state and transient analyses.

As mentioned, an optimization methodology may be for a single well or multiple wells. In various trials, such a technique provides a solution that can readily maximize oil production for available lift gas for a single well. As to two or more wells, a controller can be utilized for field control operations that can improve a solution over several increments, for example, to reach a field-wide set-point scheme that can maximize production subject to resource and operational constraints.

As an example, a simulation model can impart high frequency rate data at desired locations, which can be provisioned in practice by real-time multiphase meters. As an example, effective operational control can be implemented using such information, which can help to ensure that imposed operating limits are met. For example, consider a sequence of operating points culminating in an optimal solution, where the operating points remain constraint feasible for the operational time span. Such a process may remain active, or be invoked as desired, for example, to provide a new set-point with changing conditions and/or constraints that may occur with respect to time. As an example, a system may provide for operation of a field near or at its most optimal for extending periods of time, which may be implemented with reduced, little or no manual intervention. Various example techniques and technologies can be scalable such that number of wells, number of constraints, etc., can be accommodated, which may occur from field to field, within a field over time, etc.

As explained with respect to the system 600 of FIG. 6, the local controller 614 may be implemented at a well site for controlling one or more pieces of equipment. As an example, control instruction may be generated locally and/or remotely. As an example, an optimization methodology may be run at least in part on one or more of a local real-time controller, a controller on the edge, a controller in the cloud, etc.

As an example, a system can include a processor (e.g., a microprocessor, microcontroller, digital signal processor, a core, cores, etc.) for executing instructions, accessing memory, issuing signals, etc.

As an example, a method can include controlling gas lift to one or more wells in a field in a manner that aims to maximize the quantity or value of the produced hydrocarbons by optimal distribution of the available lift-gas under stipulated operating constraints.

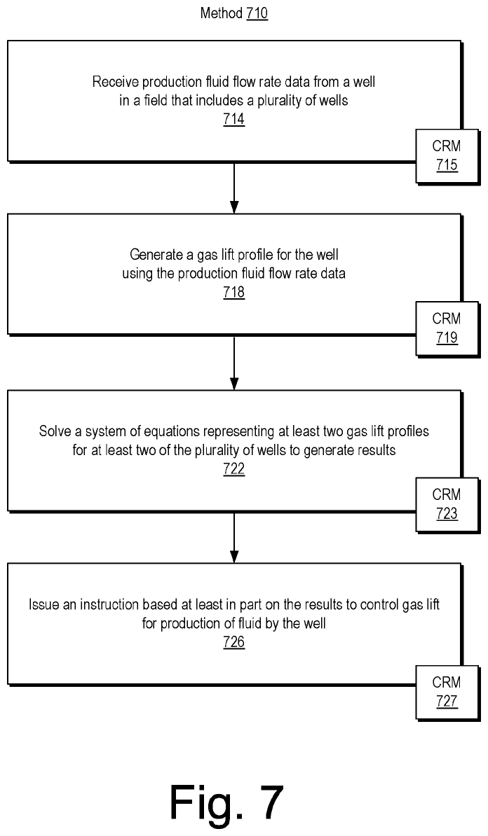

FIG. 7 shows an example of a method 700 that can include a reception block 714 for receiving production fluid flow rate data from a well in a field that includes a plurality of wells; a generation block 718 for generating a gas lift profile for the well using the production fluid flow rate data; a solution block 722 for solving a system of equations representing at least two gas lift profiles for at least two of the plurality of wells to generate results; and an issuance block 726 for issuing an instruction based at least in part on the results to control gas lift for production of fluid by the well.

The method 700 is shown in FIG. 7 in association with various computer-readable media (CRM) blocks 715, 719, 723 and 727. Such blocks generally include instructions suitable for execution by one or more processors (or cores) to instruct a computing device or system to perform one or more actions. While various blocks are shown, a single medium may be configured with instructions to allow for, at least in part, performance of various actions of the method 700. A computer-readable medium (CRM) may be a computer-readable storage medium that is not a carrier wave, that is not a signal and that is non-transitory. As an example, the system 600 can include features suitable for execution of one or more of the CRM blocks 715, 719, 723 and 727, which may be implemented in one or more manners such as, for example, one or more of local, remote and local and remote. For example, consider utilization of the local services 610 and/or the cloud services 620 to perform the method 700 of FIG. 7 for at least one well in a field that includes a plurality of wells that may be in fluid communication with a common reservoir. In such an example, the method 700 may be applied to one or more of the plurality of wells, for example, to optimize utilization of a resource such as, for example, available lift gas.

As explained, control may be implemented using one or more types of equipment, which can include one or more valves, which may include one or more surface valves and/or one or more downhole valves. As an example, a downhole valve may be controllable electronically or not; noting that a downhole valve may be controlled responsive to one or more of electronic signals, temperature, pressure, etc. As to temperature, consider a temperature responsive mechanism that can adjust and/or actuate one or more features of a valve (e.g., a metal or alloy that may change shape dependent on temperature, etc.). As explained, a valve can include features that change responsive to pressure such as a pressure differential. As to an electronically controllable valve, consider a valve that may be programmed for adjustment responsive to local and/or remote conditions and/or responsive to an instruction, which may be transmitted to the valve (e.g., an actuator, etc.).

As an example, a control scheme can include a defined field of interest that includes n gas lifted wells, each configured with suitable gas lift injection capability. In addition, the quantity of available gas for distribution can be denoted C at a given time t. In such a scheme, a liquid flow rate qᵢ at a wellhead of the i-th well can be readable (e.g., measurable, etc.), and fluid properties can be known with some degree of certainty. For example, let αᵢ and βᵢ indicate the water-cut (WC) and gas-oil-ratio (GOR), respectively. Thus, by adopting a suitable sampling and interpolation scheme, it is possible to generate a representative lift profile for each well. Such an approach can serve to indicate the relationship of the liquid flowrate with gas-injection. Hence, gathered data can be used to construct a polynomial qᵢ that is a function of the gas injection rate xᵢ. In such an example, oil, water and gas flowrates for the i-th well (qₒᵢ, q_{wi}, q_{gi}) can be defined as follows:

q₀ᵢ(xᵢ)=(1−αᵢ)qᵢ(xᵢ) (1)

q_{wi}(xᵢ)=αᵢqᵢ(xᵢ) (2)

q_{gi}(xᵢ)=βᵢqₒ(xᵢ)=(1−αᵢ)qᵢ(xᵢ) (3)

where xᵢ indicates the gas lift rate allocated to well i, and is component of the set of control variables X ∈ Rⁿ.

As an example, a general optimization problem can be stated as follows:

$$max F ( X ) = {\sum }_{i = 1}^{n} {f}_{i} ( {x}_{i} ) \qquad ( 4 )$$

$$s . t {\sum }_{i = 1}^{n} {x}_{i} \leq C$$

$${L}_{i} \leq {x}_{i} \leq {U}_{i}$$

where F(X) is the objective function based on the collective measure from each well fᵢ(xᵢ). Above, the lower and upper bounds of the i-th variable are indicated by Lᵢ and Uᵢ, respectively.

A control scheme can include defining a current operating point Xₒ. In such an example, it may be assumed that each well can be perturbed locally without impacting or affecting another well in the near term. Given such a formulation, it is possible to elicit sensitivity information at the incumbent operating point for each well. For example, if the i-th well is operating at xᵢ=aᵢ, the first and second order sensitivity can be established as follows:

$${j}_{i} ( {a}_{i} ) = \frac{f ( {a}_{i} + δ {x}_{i} ) - f ( {a}_{i} )}{δ {x}_{i}} \qquad ( 5 )$$

$${h}_{i} ( {a}_{i} ) = \frac{f ( {a}_{i} + δ {x}_{i} ) - 2 f ( {a}_{i} ) + f ( {a}_{i} - δ {x}_{i} )}{δ {x}_{i}^{2}} \qquad ( 6 )$$

As an example, a control scheme can include constructing a local representation using a Taylor series expansion of the actual (unknown) response at xᵢ=aᵢ. In such an example, the liquid rate for each well can be approximated as follows:

$${p}_{i} ( {x}_{i} ) = f ( {a}_{i} ) + \frac{{j}_{i} ( {a}_{i} )}{1 !} ( {x}_{i} - {a}_{i} ) + \frac{{h}_{i} ( {a}_{i} )}{2 !} {( {x}_{i} - {a}_{i} )}^{2} … \qquad ( 7 )$$

where the dots indicate higher-order representation if desired. With suitable sensitivity information, each response pᵢ can be modeled, for example, by one or more of a representative linear, quadratic or higher-order polynomial. In such an example, a choice may depend on the ease with which the sensitivity information is obtained and the subsequent solution method adopted. As an example, a sequence of incrementally increasing gas lift rate adjustments may be desirable from a practical point of view. For example, a controller may issue a signal to an actuator or actuators that can make incremental adjustments as to gas lift rate.

The second-order Taylor series expansion (7) can be parameterized at x=a by the function value f(a) and local sensitivity information, j(a) and h(a), as follows:

$$p ( x ) = f ( a ) + j ( a ) ( x - a ) + \frac{h ( a )}{2} {( x - a )}^{2} \qquad ( 8 )$$

The foregoing equation can be rearranged for polynomial coefficients giving:

$$p ( x ) = \frac{h ( a )}{2} {x}^{2} + [ j ( a ) - ah ( a ) ] x + f ( a ) - aj ( a ) + \frac{{a}^{2}}{2} h ( a ) \qquad ( 9 )$$

and hence:

p(x)=Ax²+Bx+C

where, the quadratic coefficients are given by

$$A = \frac{h ( a )}{2} ,$$

B=j(a)−ah(a) and C=f(a)−aj(a)+0.5a²h(a).

As an example, a control scheme can include assuming that well behavior (liquid rate versus gas lift rate) at a time t is defined for each well i ∈ [0 n] with a descriptive polynomial obtained from Taylor series expansion at the current operation point xₒ (as described above):

qᵢ(xᵢ)=Aᵢxᵢ²+Bᵢxᵢ+Cᵢ (10)

In addition, such a control scheme can assume that the water-cut and gas-oil-ratio of well i are known, and are denoted α₁ and βᵢ, respectively. In such an example, the objective function for cumulative liquid may then be defined as:

$$F ( X ) = {\sum }_{i = 1}^{n} {q}_{i} ( {x}_{i} ) \qquad ( 11 )$$

and the objective measure for oil production can be stated as:

$$F ( X ) = {\sum }_{i = 1}^{n} {q}_{oi} ( {x}_{i} ) = {\sum }_{i = 1}^{n} ( 1 - {α}_{i} ) {q}_{i} ( {x}_{i} ) \qquad ( 12 )$$

where qₒᵢ is the oil rate of i-the well.

As an example, a value-based measure can be specified as follows (e.g., noting dependence on xᵢ):

$$\begin{matrix}F ( X ) = {p}_{o} {\sum }_{i = 1}^{n} {q}_{oi} + {p}_{g} {\sum }_{i = 1}^{n} {q}_{gi} - {k}_{w} {\sum }_{i = 1}^{n} {q}_{wi} - {k}_{g} {\sum }_{i = 1}^{n} {x}_{i} & \end{matrix} \qquad ( 13 )$$

where q_{wi} and q_{gi} are the water and gas rates of the i-th well. In addition, pₒ and p_{g} can be defined as the unit oil and gas production values, respectively, while k_{w} and k_{g} are the unit produced water disposal and gas injection cost, respectively.

Thus, Equation (13) provides a measure of value for the collective production over all n wells. As an example, a general objective can be stated as:

$$F ( X ) = {p}_{o} {\sum }_{i = 1}^{n} ( 1 + {α}_{i} ) {q}_{i} + {p}_{g} {\sum }_{i = 1}^{n} {β}_{i} ( 1 - {α}_{i} ) {q}_{i} - {k}_{w} {\sum }_{i = 1}^{n} {α}_{i} {q}_{i} - {k}_{g} {\sum }_{i = 1}^{n} {x}_{i} \qquad ( 14 )$$

or more compactly as:

F(X)=VQ−K_{g}X (15)

where Q(X) is the liquid flow rate array [n,1] with component qᵢ(xᵢ), X is the vector of gas lift rates [n,1] and K_{g} is a row of gas-injection cost [1,n]. The vector V ([1,n]) is the unit production value array, where each component vᵢ is defined as follows:

vᵢ=[pₒ(1−α₁)+p_{g}βᵢ(1−αᵢ)−k_{w}αᵢ] (16)

Note that if pₒ is set to one and the other cost components (p_{g}, k_{w} and k_{g}) are set to zero, the objective can be to maximize the oil production. If αᵢ is also set to zero, the liquid rate can be established.

As an example, a primary resource constraint can be available lift gas. In addition, one or more bounds may be specified for each well based on one or more of a minimum injection requirement and an upper injection restriction. However, given that the fluid properties are known, a control scheme can also include asserting one or more well or cumulative field quantities by phase. For example, consider a set of constraints (m=5+6n) as follows:

$$( 1 ) {\sum }_{i = 1}^{n} {x}_{i} \leq C \\ ( 1 ) {\sum }_{i = 1}^{n} {q}_{i} \leq {B}_{l} \\ ( 1 ) {\sum }_{i = 1}^{n} {q}_{oi} \leq {B}_{o} \\ ( 1 ) {\sum }_{i = 1}^{n} {q}_{wi} \leq {B}_{w} \\ ( 1 ) {\sum }_{i = 1}^{n} {q}_{gi} \leq {B}_{g} \\ ( n ) {q}_{i} \leq {B}_{li} \\ ( n ) {q}_{oi} \leq {B}_{oi} \\ ( n ) {q}_{wi} \leq {B}_{wi} \\ ( n ) {q}_{gi} \leq {B}_{gi} \\ ( n ) {x}_{i} \geq {L}_{i} \\ ( n ) {x}_{i} \leq {U}_{i} \qquad ( 17 )$$

where, above, the number of equations expected for each type is given in brackets and the B -items represent right-hand limits. In particular, C is the available gas limit, and Bᵢ, Bₒ, B_{w} and B_{g} are the cumulative liquid, oil, water and gas rates, respectively. The limits by well are similarly asserted with index i. Lastly, the lower and upper bounds of the i-th variable are given in the last two rows. For n=2, this results in m=17 nonlinear inequality constraints.

Stated in standard form, the constraint set may be given as:

$$( 1 ) {\sum }_{i = 1}^{n} {x}_{i} - C \leq 0 \\ ( 1 ) {\sum }_{i = 1}^{n} {q}_{i} - {B}_{l} \leq 0 \\ ( 1 ) {\sum }_{i = 1}^{n} {q}_{i}^{o} - {B}_{o} \leq 0 \\ ( 1 ) {\sum }_{i = 1}^{n} {q}_{i}^{w} - {B}_{w} \leq 0 \\ ( 1 ) {\sum }_{i = 1}^{n} {q}_{i}^{g} - {B}_{g} \leq 0 \\ ( n ) {q}_{i} - {B}_{li} \leq 0 \\ ( n ) {q}_{oi} - {B}_{oi} \leq 0 \\ ( n ) {q}_{wi} - {B}_{wi} \leq 0 \\ ( n ) {q}_{gi} - {B}_{gi} \leq 0 \\ ( n ) {L}_{i} - {x}_{i} \leq 0 \\ ( n ) {x}_{i} - {U}_{i} \leq 0 \qquad ( 18 )$$

As an example, another constraint that can be added may restrict a step-change from the current operating point, Xₒ. For example, consider specifying via a Euclidean norm as follows:

∥X, X_{O}∥≤dₘₐₓ (19)

As an example, for a system with n wells (see, e.g., FIG. 5 where one or more wells may be present), there can be a collection of m=6(n+1) constraints. In such an example, a control scheme can let G(X)≤0 represent such a set of constraints compactly, regardless of which constraints are applied (e.g., noting that setting particular right-hand side terms to infinity can ensure that one or more constraints are inactive, e.g., feasible). As an example, a general problem can be stated as:

maxF(X) (20)

s.tG(X)≤0

xᵢ>0 ∀ i ∈ [1 n]

As an example, one or more additional or alternative constraints may be specified. As explained, a problem can be formulated to maximize the stipulated objective function over the set of all constraints. Such an approach can provide for control of one or more gas lift mechanisms in a field or fields.

As an example, a control scheme can include formulating an optimization problem with nonlinear inequalities (20) that can be solved, for example, with an interior point method (IPM) (e.g., noting that a sequential quadratic programming (SQP) method may be utilized). An IPM-based approach can provide a numerical scheme using Newton's method, along with some assurance that the solution path is feasible. Such desirable behavior ensures that a feasible solution can be output.

As an example, a method can include converting a set of inequalities to equalities, for example, with the addition of slack variables:

min−F(X)

s.t.−G(X)−S=0

xᵢ>0 ∀ i ∈ [1 n]

sᵢ>0 ∀j ∈ [1 m] (21)

where S ∈ R^{m} is the set of slack variables, with j-th component sᵢ≥0.

For convenience, Equations (21) can be restated for the collective set of N=n+m variables:

min f(x)

s.t.C(x)=0

xᵢ>0 ∀ i ∈ [1 n] (22)

where x ∈ R^{N}. Next, a log-barrier form can be utilzied to replace the non-negativity requirement in (22) giving:

$$min f ( x ) - μ {\sum }_{i = 1}^{N} ln ( {x}_{i} ) \\ s . t . C ( x ) = 0 \qquad ( 23 )$$

where μ is a scalar multiplier that conditions the barrier term. Above, the parameter can be reduced towards zero to allow the solution to reach an active constraint boundary (e.g., a multiplier term can be fixed for a given problem, but may be reduced over a sequence of such problems).

The KKT conditions for optimality can impose the following:

∇f(x)+∇C(x)λ−Z=0

C(x)=0

XZe−μe=0 (24)

where X is a diagonal array of x, Z is a diagonal array of z with element zᵢ=μ/xᵢ, and e is a column of ones.

As an example, a symmetric linear system can be defined in compact terms as follows:

$$( \begin{matrix}{W}_{k} + {\sum }_{k} & ∇ C ( {x}_{k} ) \\ ∇ {C}^{T} ( {x}_{k} ) & 0\end{matrix} ) \cdot ( \begin{matrix}{d}_{k}^{x} \\ {d}_{k}^{λ}\end{matrix} ) = - ( \begin{matrix}∇ f ( {x}_{k} ) + ∇ C ( {x}_{k} ) . {λ}_{k} \\ C ( {x}_{k} )\end{matrix} ) \qquad ( 25 )$$

where Wₖ=∇ₓₓ²(f(xₖ)+C^{T}(xₖ)λₖ−Zₖ) and Σₖ=Xₖ⁻¹Zₖ.

Above, the step updates dₖ^{z} can be obtained once the system of equations (25) is solved for the step updates dₖ^{x} and dₖ^{λ} as follows:

dₖ^{z}=μₖX⁻¹e−Zₖ−Σₖdₖ^{x} (26)

In such an example, an update can be based on the selected step-size αₖ , where a value of one indicates a full Newton step update. As an example, a line search can be performed to establish the value of a that minimizes a merit function that provides a combined measure of the objective and constraint requirements. For example, an update can be made and the procedure repeats until convergence of this inner-loop.

xₖ₊₁=xₖ+αₖdₖ

λₖ₊₁=λₖ+αₖdₖ^{λ}

zₖ₊₁=zₖ+αₖdₖ^{z} (27)

A homotopy scheme is used with Equation (23) with decreasing μ in the outer-loop. As a result, a sequence of unconstrained optimization problems are solved until the optimality conditions in Equation (24) are within given tolerances, as follows:

max|∇f(x)+∇C(x)λ−Z|≤ε₁

max|C(x)=0|≤ε₂

max|XZe−μe≡≤ε₃ (28)

As an example, a greater weight may be assigned to ε₃ for the constraint condition.

The foregoing interior point scheme may be readily defined and implemented for purposes of control; noting that a feasible starting point is to be provided. Hence, for general application, an initial feasibility problem may be solved to provide such a starting point. However, for the gas lift optimization problem, it is evident that xᵢ=Lᵢ is quite likely to be feasible and can be utilzied as a recommended starting point.

As an example, a control scheme can include various other processes such as, for example, step-size selection, the balance between the number of inner and outer iterations, among others. As explained, an interior point scheme can be used to solve the inequality constrained problem (20) in a robust manner following a feasible path to the optimal solution. Thus, if the solver is terminated early for one or more reasons (e.g., practical or other reasons), the resulting solution can still be constraint feasible.

Below, various examples of techniques, methods, etc., are presented for single and multiple well scenarios.

Single Well—Set Operating Point

Given desired point xₒ

Set xₒ as operating point

Establish actual flowrate f(xₒ)

Return f(xₒ)

Single Well—Step Rate Test

Given current operating point xₒ, f(xₒ)

Specify xₘᵢₙ, xₘₐₓ, nₛₜₑₚ

Specify Xₛₜₑₚ=(xₘₐₓ−xₘᵢₙ)/nₛₜₑₚ

Initialize k=1

Iterate while (x≤xₘₐₓ)
x=xₘᵢₙ+k(xₛₜₑₚ)
Set x as operating point
Establish actual flowrate f(x)
Store (x,f(x))
Set k=k+1

Use tabular data [X F] to establish model q(x)

Return model q(x)

Single Well—Sensitivity

Given current operating point xₒ, f(xₒ)

Specify perturbation factor δx

Set x₁=xₒ+δx

Set x₁ as operating point

Establish actual flowrate f(x₁)

Set x₂=x₁+δx

Set x₂ as operating point

Establish actual flowrate f(x₂)

Evaluate Jacobian j(xₒ)

Evaluate Hessian h(xₒ)

Return j(xₒ) and h(xₒ)

Single Well—Taylor Series Expansion

Given current conditions (xₒ, f(xₒ), j(xₒ) and h(xₒ))

Construct representative polynomial:

q(x)=f(xₒ)+j(xₒ)(x−xₒ)+0.5h(xₒ)(x−xₒ)²

Return approximating model q(x)

Single Well—Evaluate Model Quantities

Given desired point x, model q(x), water-cut α and GOR β

Establish q(x)

Establish qₒ(x)=(1−α)q(x)

Establish q_{w}(x)=αq(x)

Establish q_{g}(x)=β(1−α)q(x)

Return q(x), qₒ(x), q_{w}(x), q_{g}(x)

Single Well—Operation

Given operating point xₒ, f(xₒ)

Get sensitivity information j(x₀) and h(x₀)

Establish Taylor expansion q(x)=ax²+bx+c

Establish optimum point x̅ over q(x)

If x̅≤Lᵢ then set x=Lᵢ→Done

If x̅≤C then set x=x̅→Done

Else set x=C→Done

Set xₒ=x

Return new set point xₒ

Repeat procedure after interval dt

Multi-well—Operation

Given Xₒ, Fₒ, C and constraint limits

For each well i ∈ [1, n] (in parallel)
Get xᵢ=X(i) and fᵢ=F(i)
Establish sensitivity j(xᵢ) and h(xᵢ)
Construct Taylor expansion qᵢ(xᵢ) giving coeff. Aᵢ, Bᵢ, Cᵢ, . . .
Establish x̅ᵢ over qᵢ(xᵢ) and update Uᵢ

If Σx̅ᵢ≤C, set \hat{x}ᵢ=x̅ᵢ

Else optimize using IPM procedure

Return New operating point Xₒ=\hat{X}

Repeat procedure after interval dt

Multi-well—Interior Point Method (IPM)

Given n well system with response q(xᵢ) and given objective F(X) and constraints G(X)

Solve min−F(X) s.t−G(X)−S=0

Return New operating point Xₒ=\hat{X}

Repeat procedure after interval dt

Multi-well—Surveillance Procedure

At time t use fast response for each well i ∈ [1, n] (in parallel)
1A: Run local step rate test
1B: Evaluate multiple samples to construct response
1C: Run sensitivity at xₒ to get j(xₒ) and h(xₒ)
Create approximating polynomial q(xᵢ)

Set operating limits (constraints, bounds, step-size)

Solve nonlinear inequality constrained problem using IPM (or SQP)

Establish \hat{X}

Set operating point Xₒ=\hat{X}

Let system equilibrate over interval dT

Repeat procedure after interval dt

Various example trials are described below, with reference to various plots, which can be part of one or more graphical user interfaces (GUI) renderable to one or more displays, for example, of one or more control systems.

An analytical case with n=2 wells is presented to demonstrate a field-wide optimization procedure. The actual well responses assumed are given by the following two functions, which are presented as polynomials:

F₁(x₁)=−x²+8x+20

F₂(x₂)=−3x²+30x−27 (29)

The cost factors and constraint limits used for the objective measures are listed in Tables 1 and 2, respectively, for reference purposes.

TABLE 1
Fixed Parameters

| | | |
|---|---|---|
| Description | Label | Value |

Cost Factors

| | | |
|---|---|---|
| Unit oil price | pₒ | 30.0 |
| Unit gas price | p_{g} | 5.0 |
| Unit water cost | k_{w} | 3.0 |
| Unit gas cost | k_{g} | 2.0 |

Water-cut and GOR

| | | |
|---|---|---|
| Well-1 Water-cut | α₁ | 0.10 |
| Well-2 Water-cut | α₂ | 0.25 |
| Well-1 Gas-oil ratio | β₁ | 6.0 |
| Well-2 Gas-oil ratio | β₂ | 11.0 |

Note:
Fixed cost factors and fluid properties.

TABLE 2
Case 1 Constraints

| | | | |
|---|---|---|---|
| Number | Description | Label | Value |

Resource and Cumulative Capacity

| | | |
|---|---|---|
| Available Gas | C | 5 or 10⁶ |
| Cumulative Liquid | Bₗ | 10⁶ |
| Cumulative Oil | Bₒ | 10⁶ |
| Cumulative Water | B_{w} | 10⁶ |
| Cumulative Gas | B_{g} | 10⁶ |
| Step size limit | dₘₐₓ | 1 or 10⁶ |

Well Limits

| | | | |
|---|---|---|---|
| n | Well Liquid | Bₗᵢ | 10⁶ |
| n | Well Oil | Bₒᵢ | 10⁶ |
| n | Well Water | B_{wi} | 10⁶ |
| n | Well Gas | B_{gi} | 10⁶ |
| n | lower bound | Lᵢ | 0.1 |
| n | lower bound | Lᵢ | 10.0 |

Note:
Constraints limits for Example 1.

In the following sections, various tests are performed with and without limits imposed on the quantity of available lift-gas and the permissible step-size per iteration (e.g., increment size per iteration, etc.).

Case 1A—Excess Gas—No Step Limit

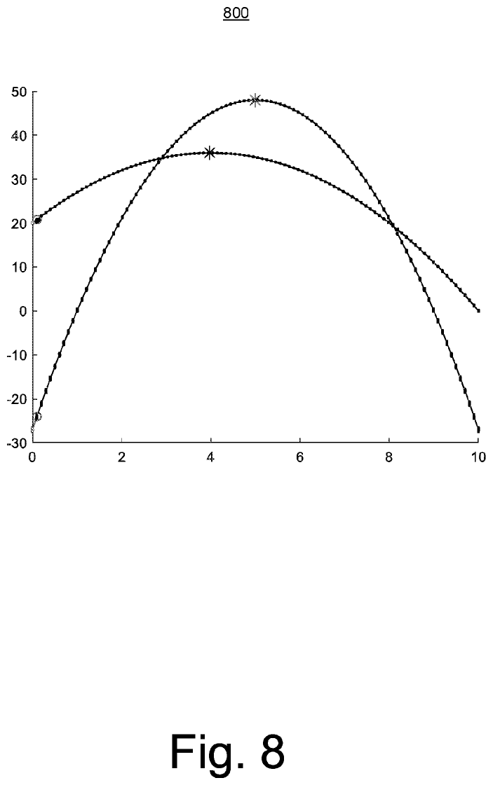

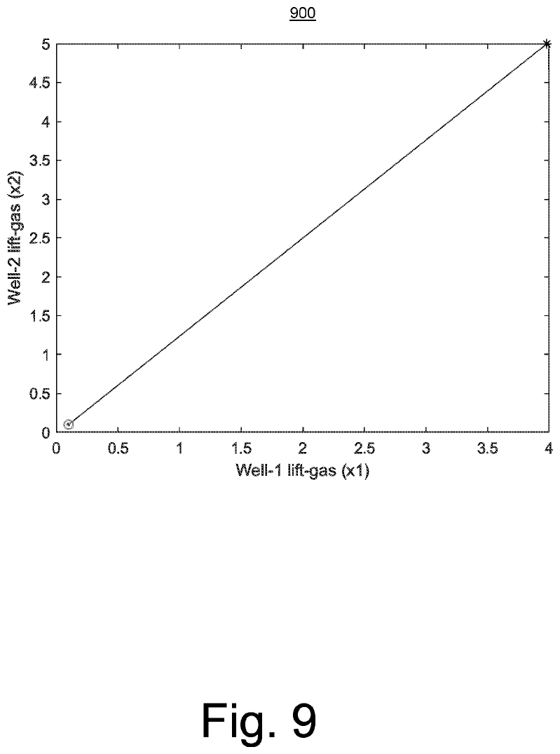

For Case 1, a trial has unlimited gas and no restriction on the step size. The results are shown in Table 3 starting from the point [0.1 0.1]. FIG. 8 shows a plot 800 of the actual and approximated models, along with the starting point (circle) and solution steps (asterisk). The quadratic model is a good approximation of reality (29) and the solution quickly reaches the unrestricted optimum in one step, as shown in FIG. 9, which shows a plot 900. The unrestricted optimal value is 4939.2 with 8.98 units of gas.

TABLE 3
Case 1A - Results

| | | | |
|---|---|---|---|
| k | x₁ | x₂ | f(X) |

| | | |
|---|---|---|
| 0.1000 | 0.1000 | gray |
| 3.9810 | 4.9972 | −4941.4 |
| 3.9814 | 4.9947 | −4939.2 |
| 3.9814 | 4.9947 | −4939.2 |
| 3.9814 | 4.9947 | −4939.2 |

Note:
Iteration k, Xₒₚₜ and Fₒₚₜ.

In FIG. 8, the plot 800 shows Case 1A well response models and set points where function F₁ with response (dots) and function F₂ with response (dots). The starting point is shown as a circle, with subsequent set points marked by asterisks.

In FIG. 9, the plot 900 shows Case 1A where the solution progress over search space from a starting point to a final point (asterisk).

Case 1B—Limited Gas—No Step Limit

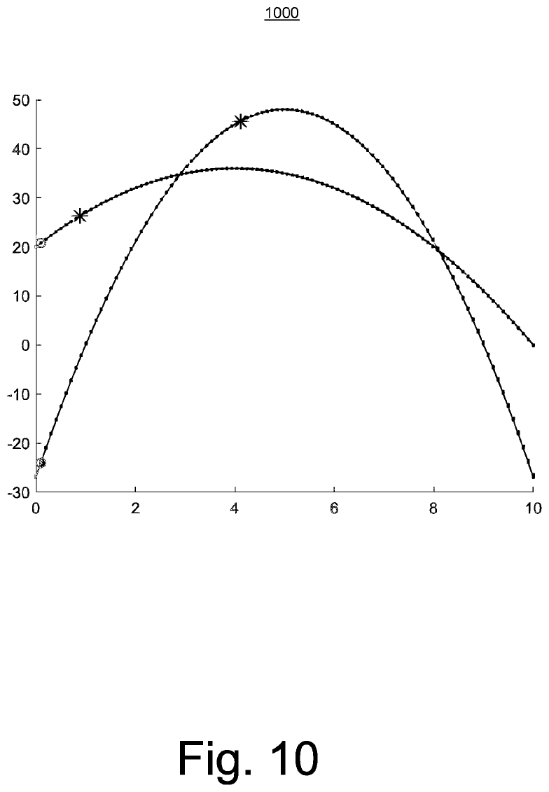

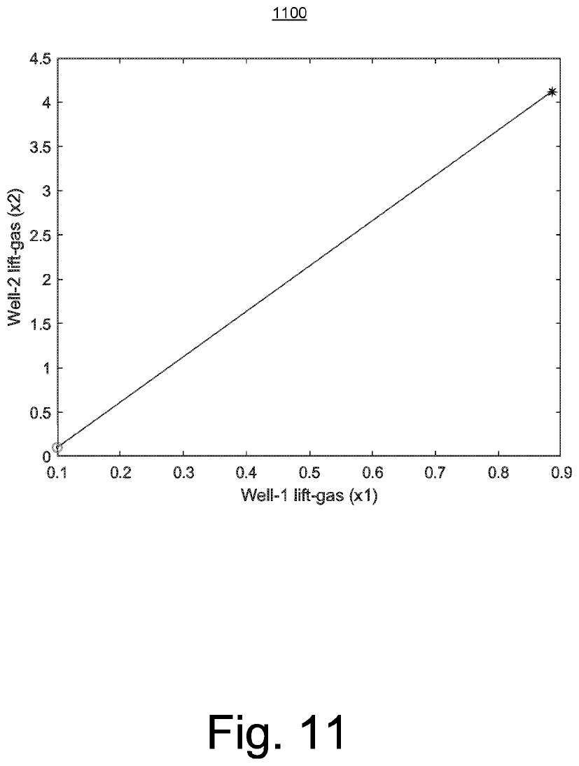

In this case, the gas is limited to 5 units and the step size is unrestricted. Results are shown in Table 4 and displayed in FIGS. 10 and 11. The gas restriction results in a value of 4278.1.

TABLE 4
Case 1B - Results

| | | | |
|---|---|---|---|
| k | x₁ | x₂ | f(X) |

| | | |
|---|---|---|
| 0.1 | 0.1 | gray |
| 0.8835 | 4.1165 | −4279.6 |
| 0.8850 | 4.1150 | −4278.1 |
| 0.8850 | 4.1150 | −4278.1 |

Note:
Iteration k, Xₒₚₜ and Fₒₚₜ.

In FIG. 10, the plot 1000 shows Case 1B well response models and set points where function F₁ is shown with response (dots) and function F₂ is shown with response (dots), along with a starting point shown as circle, with subsequent set points marked by asterisks.

In FIG. 11, the plot 1100 shows Case 1B solution progress over search space with a starting point (circle) and a final point (asterisk).

Case 1C—Excess Gas—Step Limit

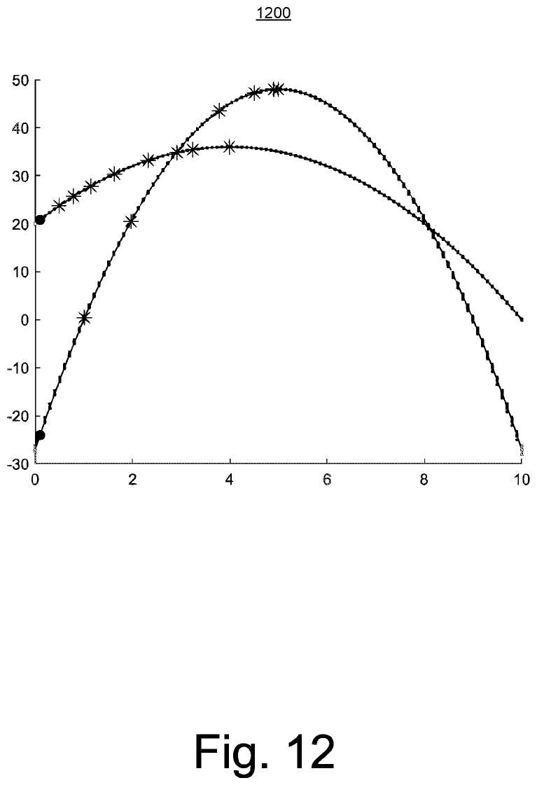

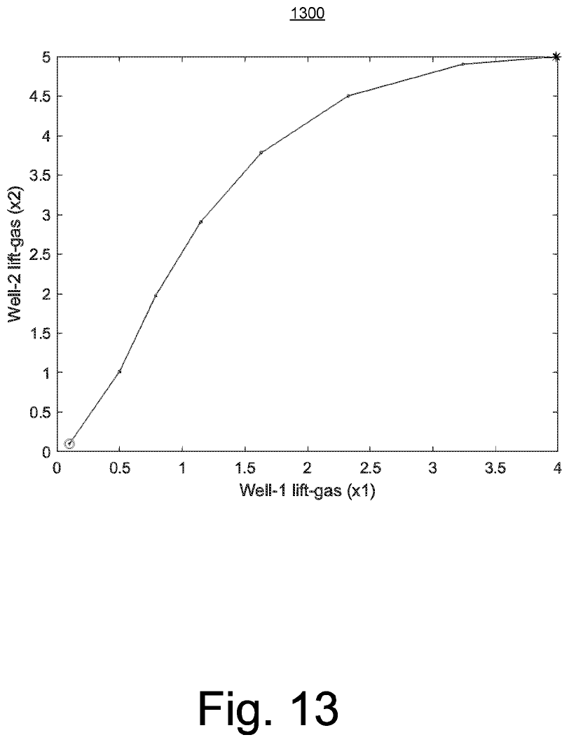

In this case, the gas is unlimited, but the permissible step size is restricted to unit length in the search space (effectively limiting the quantity of gas that can be used per step). Results are shown in Table 5 and in FIGS. 12 and 13. The unrestricted solution of 4939.2 is obtained, as per Case 1A, but over several steps due to the step-size restriction.

TABLE 5
Case 1C - Results

| | | | |
|---|---|---|---|
| k | x₁ | x₂ | f(X) |

| | | |
|---|---|---|
| 0.1 | 0.1 | gray |
| 0.5 | 1.0165 | −1297.3 |
| 0.7878 | 1.9742 | −2667.2 |
| 1.1477 | 2.9072 | −3684.3 |
| 1.6308 | 3.7827 | −4364.6 |
| 2.3257 | 4.5018 | −4745.2 |
| 3.2417 | 4.9031 | −4908.2 |
| 3.9826 | 4.9945 | −4939.3 |
| 3.9826 | 4.9945 | −4939.2 |

Note:
Iteration k, Xₒₚₜ and Fₒₚₜ.

In FIG. 12, the plot 1200 shows Case 1C well response models and set points with function F₁ with response (dots) and function F₂ with response (dots) along with a starting point shown as circle, with subsequent set points marked by asterisks.

In FIG. 13, the plot 1300 shows Case 1C solution progress over search space with a starting point (circle) and a final point (asterisk).

Case 1D—Limited Gas—Step Limit

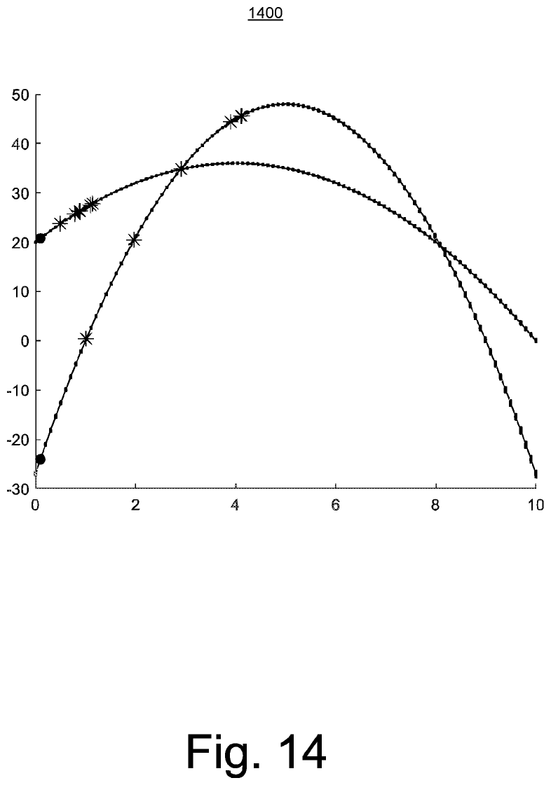

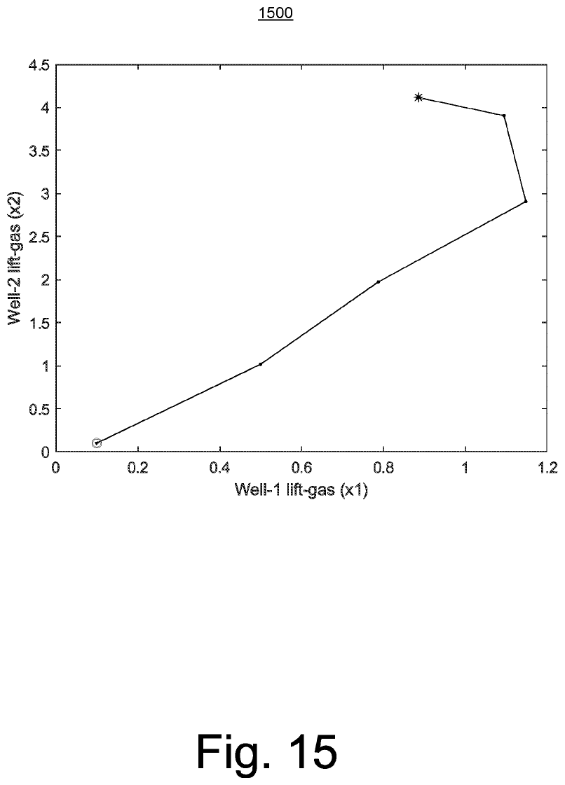

In this case, the gas is limited to 5 units and the step size is also restricted to unit length. Results are shown in Table 6 and in FIGS. 14 and 15. The restricted solution of 4278.1 is obtained, as per Case 1B, but over several steps due to the step-size restriction.

TABLE 6
Case 1D - Results

| | | | |
|---|---|---|---|
| k | x₁ | x₂ | f(X) |

| | | |
|---|---|---|
| 0.1 | 0.1 | gray |
| 0.5 | 1.0165 | −1297.3 |
| 0.7878 | 1.9742 | −2667.2 |
| 1.1481 | 2.9071 | −3683.9 |
| 1.0944 | 3.9056 | −4268.0 |
| 0.88466 | 4.1153 | −4278.1 |
| 0.88505 | 4.115 | −4278.1 |
| 0.88504 | 4.115 | −4278.1 |
| 0.88504 | 4.115 | −4278.1 |

Note:
Iteration k, Xₒₚₜ and Fₒₚₜ.

In FIG. 14, a plot 1400 for Case 1D well response models and set points shows function F₁ with response (dots) and function F₂ with response (dots) along with a starting point shown as circle, with subsequent set points marked by asterisks.

In FIG. 15, a plot 1500 for Case 1D solution progress over search space shows a starting point (circle) and a final point (asterisk).

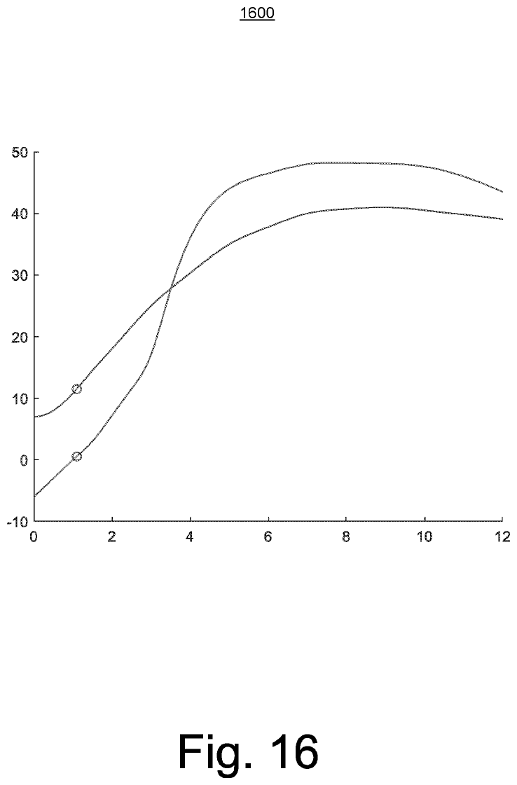

In examples, the representative well curves were given in quadratic form, which allowed for the second-order approximating model to accurately predict the response over an entire domain. However, there can be inherent complexity of the nonlinear dynamics associated with multiphase flow in wells of varying design (e.g., dimension, trajectory, fluid type, etc.). In that regard, representative lift profiles are used in this example, as shown in FIG. 16. The raw data for each curve are given in Table 7.

The revised constraint limits are listed in Table 8, while the fixed cost parameters are the same as those presented in Table 1 earlier. The starting point for this case is [1.1 1.1]. Again, FIG. 16 shows a plot 1600 of well response models and set points.

TABLE 7
Case 2 Data

| | |
|---|---|
| Well 1 | Well 2 |

| Lift | Liquid | Lift | Liquid |
|---|---|---|---|
| Gas | Rate | Gas | Rate |
| | 7 | 0 | −6 |
| .5 | 8 | 0.5 | −3 |
| | 10.8 | 1 | 0 |
| .5 | 14.5 | 1.5 | 3 |
| | 18 | 2 | 7.2 |
| | 25 | 2.5 | 11.5 |
| | 30.3 | 3 | 17 |
| | 35 | 3.5 | 27.6 |
| | 37.8 | 4 | 36 |
| | 40 | 5 | 44 |
| | 40.7 | 6 | 46.5 |
| | 41 | 7 | 48 |
| | 40.5 | 8 | 48.2 |
| | 39.8 | 9 | 48.1 |
| | 39.1 | 10 | 47.6 |
| gray | gray | 11 | 46 |
| gray | gray | 12 | 43.5 |

Note:
Spline interpolation is used to represent F₁ and F₂

TABLE 8
Case 2 Constraints

| | | | |
|---|---|---|---|
| Number | Description | Label | Value |

Resource and Cumulative Capacity

| | | |
|---|---|---|
| Available Gas | C | 12 or 10⁶ |
| Cumulative | Bₗ | 10⁶ |
| Liquid | | |
| Cumulative Oil | Bₒ | 10⁶ |
| Cumulative | B_{w} | 10⁶ |
| Water | | |
| Cumulative Gas | B_{g} | 10⁶ |
| Step size limit | dₘₐₓ | 1 or 10⁶ |

Well Limits

| | | | |
|---|---|---|---|
| n | Well Liquid | Bₗi | 10⁶ |
| n | Well Oil | Bₒi | 10⁶ |
| n | Well Water | B_{w}i | 10⁶ |
| n | Well Gas | B_{g}i | 10⁶ |
| n | lower bound | Lᵢ | 1.0 |
| n | lower bound | Lᵢ | 10.0 |

Note:
Constraints limits for Example 2.

Case 2A—Excess Gas—No Step Limit

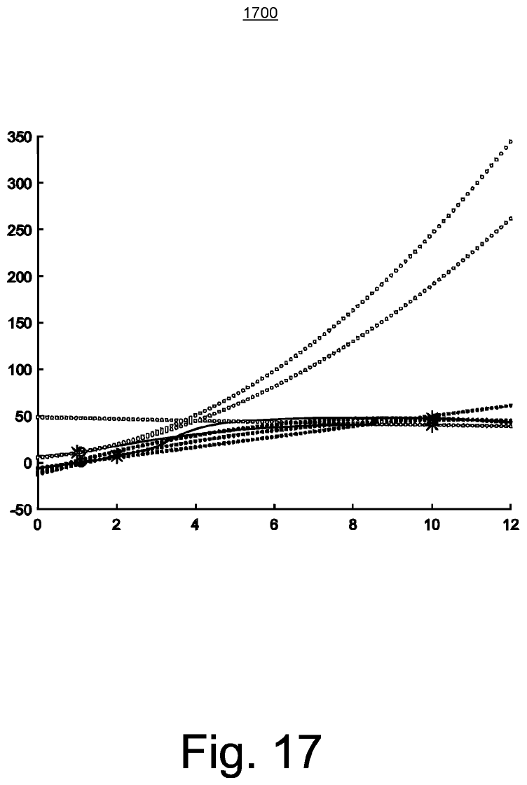

In this case, the available gas is set to be unlimited and the step size is set to be unrestricted. The results in Table 9 show that the solution bounces between two extremes, which can be a consequence of quality of an approximating model generated at the starting point and an unrestricted step change that results in another model of low quality at the subsequent point. In other words, the local approximation leads to rising convex forms that push the solution towards the higher tail in each case (see FIGS. 16 and 17); noting that well-2 is problematic.

According to the foregoing example, in various instances certain well data cannot guarantee upper convex profiles. As an example, a step-size restriction (see Equation (19)) can be introduced to enforce acceptance of the approximating model, for example, in the near vicinity of the current operating point, as explained below.

TABLE 9
Case 2A - Results

| | | | |
|---|---|---|---|
| k | x₁ | x₂ | f(X) |

| | | |
|---|---|---|
| 1.1 | 1.1 | gray |
| 10 | 2 | −10546 |
| 1 | 10 | −5419.3 |
| 10 | 2 | −13933 |
| 1 | 10 | −5419.3 |
| 10 | 2 | −13919 |
| 1 | 10 | −5438.3 |
| 10 | 2 | −13922 |
| 1 | 10 | −5426.4 |

Note:
Iteration k, Xₒₚₜ and Fₒₚₜ.

FIG. 17 shows a plot 1700 of Case 2A well response models and set points with function F₁ with response (open dots) and function F₂ with response (filled dots) along with a starting point shown as a circle, with subsequent set points marked by asterisks.

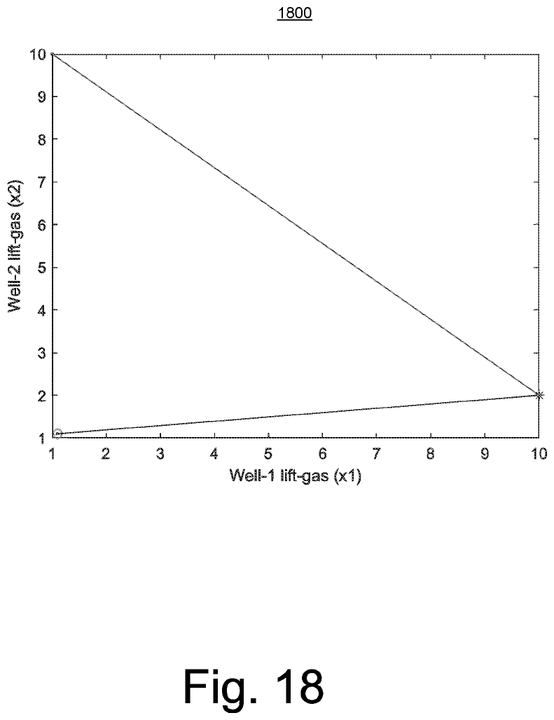

FIG. 18 shows a plot 1800 of Case 2A solution progress over search space with a starting point (circle) and final point (asterisk).

Case 2B—Excess Gas—Step Limit

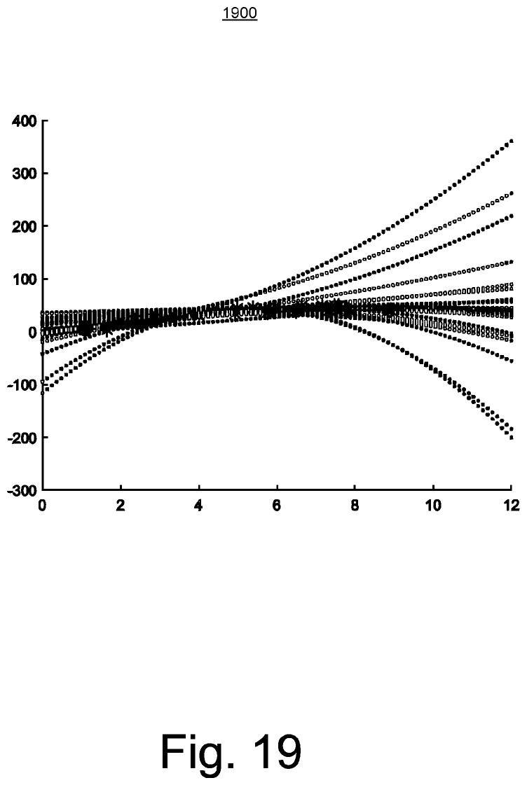

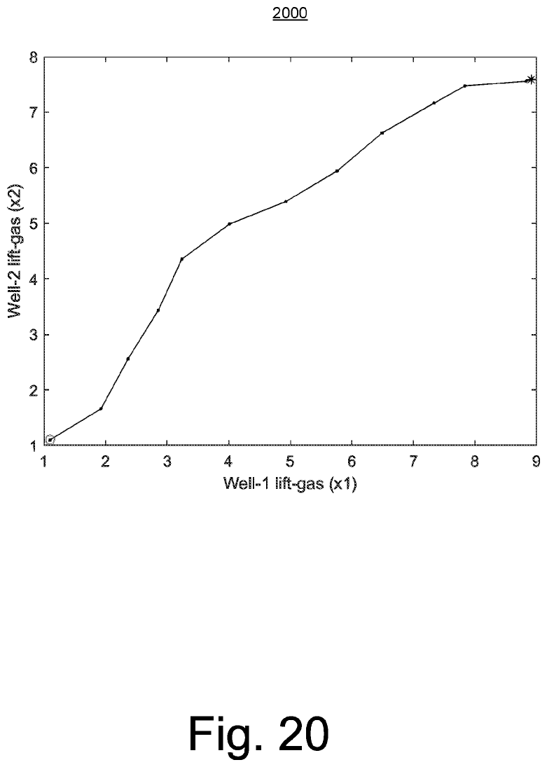

In this case, the available gas is unlimited, but the step size is restricted to unit length. Results are shown in Table 10 and displayed in FIGS. 19 and 20. While the initial approximating model is experiences some difficulty (as observed previously), a step-size restriction allows the solution to progress towards the unlimited optimum, with value 5207.0 and requiring 16.5 units of lift-gas.

TABLE 10
Case 2B - Results

| | | | |
|---|---|---|---|
| k | x₁ | x₂ | f(X) |

| | | |
|---|---|---|
| 1.1 | 1.1 | gray |
| 1.9286 | 1.6598 | −1219.1 |
| 2.367 | 2.5586 | −1958.4 |
| 2.8571 | 3.4302 | −2565.8 |
| 3.2405 | 4.3539 | −4028.7 |
| 4.0151 | 4.9863 | −4345.8 |
| 4.9297 | 5.3906 | −4719.4 |
| 5.7634 | 5.9428 | −4879.6 |
| 6.4937 | 6.6259 | −5060.8 |
| 7.3362 | 7.1646 | −5187.7 |
| 7.8367 | 7.4735 | −5185.5 |
| 8.8332 | 7.5580 | −5204.9 |
| 8.9129 | 7.5874 | −5207.0 |
| 8.9129 | 7.5874 | −5207.0 |

Note:
Iteration k, Xₒₚₜ and Fₒₚₜ.

FIG. 19 shows a plot 1900 for Case 2B well response models and set points with function F₁ with response (open dots) and function F₂ with response (filled dots) along with a starting point shown as circle and subsequent set points marked by asterisks.

FIG. 20 shows a plot 2000 for Case 2B solution progress over search space with a starting point (circle) and a final point (asterisk).

Case 2C—Limited Gas—Step Limit

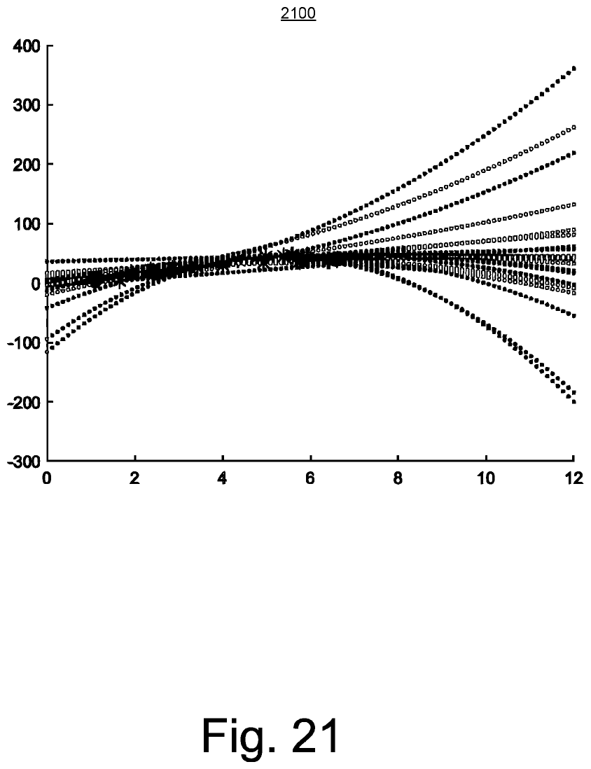

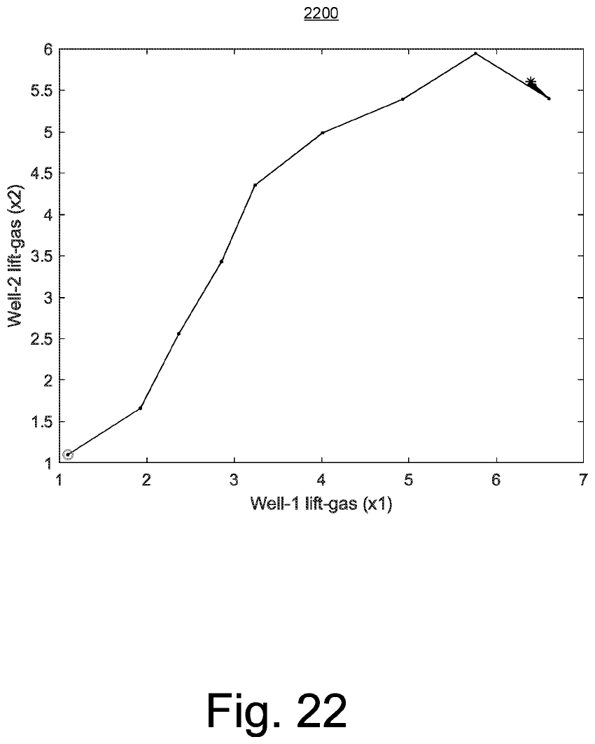

In Case 2C, available gas is limited to 12 units and the step size is restricted to a unit length. Results are shown in Table 11 and displayed in FIGS. 21 and 22. The constrained solution of 4942.2 is obtained.

TABLE 11
Case 2C - Results

| | | | |
|---|---|---|---|
| k | x₁ | x₂ | f(X) |

| | | |
|---|---|---|
| 1.1 | 1.1 | gray |
| 1.9286 | 1.6598 | −1219.1 |
| 2.3670 | 2.5586 | −1958.4 |
| 2.8572 | 3.4302 | −2565.9 |
| 3.2404 | 4.3539 | −4028.8 |
| 4.0151 | 4.9862 | −4345.9 |
| 4.9297 | 5.3905 | −4719.4 |
| 5.7638 | 5.9422 | −4879.5 |
| 6.6024 | 5.3976 | −4941.0 |
| 6.4384 | 5.5616 | −4941.7 |
| 6.3995 | 5.6005 | −4942.2 |
| 6.3971 | 5.6029 | −4942.2 |

Note:
Iteration k, Xₒₚₜ and Fₒₚₜ.

FIG. 21 shows a plot 2100 of Case 2C well response models and set points with function F₁ with response (open dots) and function F₂ with response (filled dots) along with a starting point shown as circle, with subsequent set points marked by asterisks.

FIG. 22 shows a plot 2200 of Case 2C solution progress over search space with a starting point (circle) and a final point (asterisk).

In a field system, data acquisition may experience various types of issue. For example, consider noise, temporal variation, etc. For example, one or more measurements (e.g., pressure, temperature, flow-rate, etc.) from one or more of various meters may have some amount of uncertainty, which may be relatively steady and/or which may vary with time, conditions, etc. As an example, in various instances, one or more gas injection rates may not be set or held at an exact value or exact values as stipulated via a control scheme. As explained, such issues may arise from data, equipment (e.g., sensors, actuator, etc.), etc.

In various instances, error may be present as a consequence of operating limitations and/or error may be present due to variation presented in measurements. Where a control scheme assumes that a set point is defined as closely as possible over time, variation(s) in measurements may be processed, for example, over a distribution of possible results from a sufficient number of samples. In such an example, an objective measure can be modified to account for such variability, for example, as follows:

F(X|ρ)=μ(X|ρ)−λσ(X|ρ) (30)

where μ and σ are the mean and standard-deviation estimates at the operating point X, and λ represents the degree of confidence desired in the result. Notably, if λ is zero, the objective is to maximize the mean response over the ensemble of samples (given by the set ρ), and for higher values of λ, a greater certitude may be sought. As explained, as an example, a may be optimized under uncertainty using an equation such as the Equation (30) and an iterative procedure, as explained above.

As an example, composition of gas may be relatively constant and/or it may change over time. For example, composition of gas may be relatively constant for a period of time and then change, where it may continually change or become relatively constant. As an example, a system can include one or more gas composition parameters that may be set to corresponding values manually, semi-automatically or automatically. For example, consider one or more composition sensors that can measure one or more characteristics of gas such that sensor generated data can be received by a system and utilized in a control scheme that aims to make gas lift more efficient, meet a desired goal, etc. In various instances, a change in conditions such as gas composition can cause an optimal solution (or other solution point during progress) to change. In various instances, a control scheme can include repeating an optimization procedure such that one or more types of disturbances can be accounted for on an ongoing basis, for example, over a desired time interval as may be appropriate to reach a local equilibrium for a given set point. As an example, where an increment size is utilized, where some amount of uncertainty exists as to one or more conditions, a control scheme may provide for sampling and/or adjusting at each increment. In such an example, the control scheme can provide for uncertainty and/or underlying condition changes such as, for example, changes in composition of gas that is to be utilized for gas lift of one or more wells.

As an example, a method can include establishing representative well lift curves based on local perturbation around an incumbent constraint-feasible operating point. In such an example, the method can include utilizing the lift curves to optimize distribution of available lift gas under various field-wide constraints.

As an example, a method may not demand numerous sample points, for example, a method may operate without evaluating multiple samples as per a rate test to establish a representative lift curve. As explained, a method can include utilizing local sensitivity information, for example, based on perturbation in a near neighborhood of an existing operating point, which can be sufficient, for example, to construct a representative polynomial using a Taylor series expansion. As explained, a method can commence from an existing state. For example, an existing state, as may be represented at least in part by an existing operating point (e.g., or operating points), may be utilized as an initial condition for a solver that aims to generate results that can include one or more new operating points.

As an example, a method may be implemented without management of a sampling process with limits on resources or bounds. For example, as a local perturbation may be made to a feasible (e.g., in-place physical solution), new sample points can also be more likely to be feasible.

As an example, a method can include handling of bound limits and other operating constraints using one or more suitable non-linear programming optimization schemes.

As an example, a method can be implemented in a manner where samples do not necessarily have to be monitored to ensure upper convexity of a representative well curve. In such an example, a method may proceed without having to pick and/or manage samples during sampling. For example, a method can include construction a local approximation using sensitivity information, which may be assumed to be reliable over a given trust region of interest. As an example, a step-size (e.g., increment size, etc.) can be regulated to help ensure that a valid, reliable and stable adjustment or adjustments is or are made at each iteration of a multiple iteration control scheme with respect to time.

As an example, a control scheme can be flexible and extensible to handle changes in conditions, introduction of new wells, closing of existing wells, etc. For example, a control scheme can be extended to a relatively large number of wells (e.g., large n) where the control scheme can be designed to handle both field-wide cumulative and local well constraints.

As an example, a method can include utilizing an objective measure that is naturally separable where, for example, a constraint set is not. In such an example, an optimization procedure can help to ensure that a constrained resource allocation problem is effectively managed over a plurality of wells in a system. In various instances where a scenario may be reduced to a single-well problem, a control scheme can handle such a scenario while being able to shift, as desired, to a multi-well scenario. For example, consider a scenario where various wells are taken offline where a single well remains operational utilizing gas lift. In such an example, a control scheme can operate dynamically to switch from multi-well optimization to single well optimization and, for example, back to multi-well optimization as appropriate.

As an example, a control scheme can utilize local approximation, update and refinement. For example, consider an approach that can optimize a system from an interior feasible point, thus maintaining constraint feasibility over a sufficiently long span of time (e.g., hours, days, etc.). Such an approach can suitably handle one or more changes in conditions (e.g., gas composition, well production and reservoir depletion), which may occur during field operations.

As an example, a method can include analyzing sensitivity, which may be, for example, repeated periodically to check if one or more conditions have changed. If so, such a method can include updating one or more approximating models where a new operating point (e.g., or points) can then be established. As an example, a previous feasible operating point can be used to seed a starting point of a solver, which may improve stability, reduce time to solution, reduce computational resource demands, etc. As an example, where one or more new or revised constraints are introduced, a method can include generating an updated solution via one or more solvers.

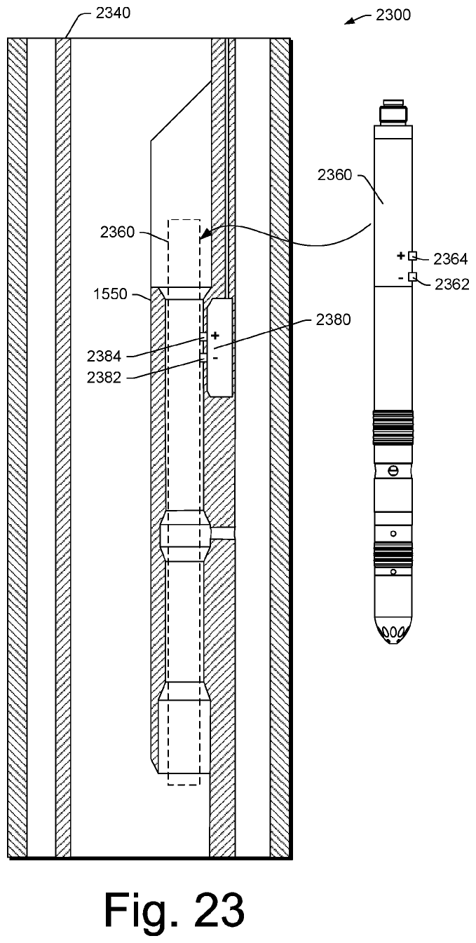

FIG. 23 shows an example of a system 2300 that includes a mandrel 2340 that includes a pocket 2350 that seats a gas lift valve 2360. As an example, the mandrel 2340 can include circuitry 2380, which may include a power supply such as, for example, one or more batteries. As shown, the circuitry 2380 may be operatively coupled to connectors 2382 and 2384, which may be disposed in a wall of the pocket 2350. In the example of FIG. 23, the gas lift valve 2360 can include one or more connectors 2362 and 2364 that can be positioned within the pocket 2350 to electrically connect to the connectors 2382 and 2384. In the example of FIG. 23, while two connectors are illustrated, a number of connectors may range from one to more than one. As an example, a connector may be a standardized connector such as, for example, a serial bus connector (e.g., USB, etc.) where power and information may be transmitted. As an example, a connector or connectors may be an interface or interfaces. As an example, a connector may be an 120 type of connector. For example, consider two bidirectional open collector or open drain lines, Serial Data Line (SDA) and Serial Clock Line (SCL), pulled up with resistors. In such an example, voltages may be approximately +5 V or +3.3 V, or one or more other voltages. As an example, a valve may be a downhole valve that is electronically controllable, for example, via surface equipment (e.g., using a downhole telemetry communication technique, etc.).

As an example, the circuitry 2380 may optionally include one or more sensors and/or one or more receivers. In such an example, information sensed and/or received by the circuitry 2380 may trigger actuation of an actuator of the gas lift valve 2360. For example, where a condition is sensed (e.g., pressure, temperature, depth, orientation, etc.), a control signal may be applied to the one or more connectors 2382 and 2384 to cause receipt of the control signal by the one or more connectors 2362 and 2364, which, in turn, cause an adjustment to be made by one of one or more actuators of the gas lift valve 2360. As an example, where a signal is received (e.g., a communication, etc.), a control signal may be applied to the one or more connectors 2382 and 2384 to cause receipt of the control signal by the one or more connectors 2362 and 2364, which, in turn, cause an adjustment to be made by one or more actuators of the gas lift valve 2360.

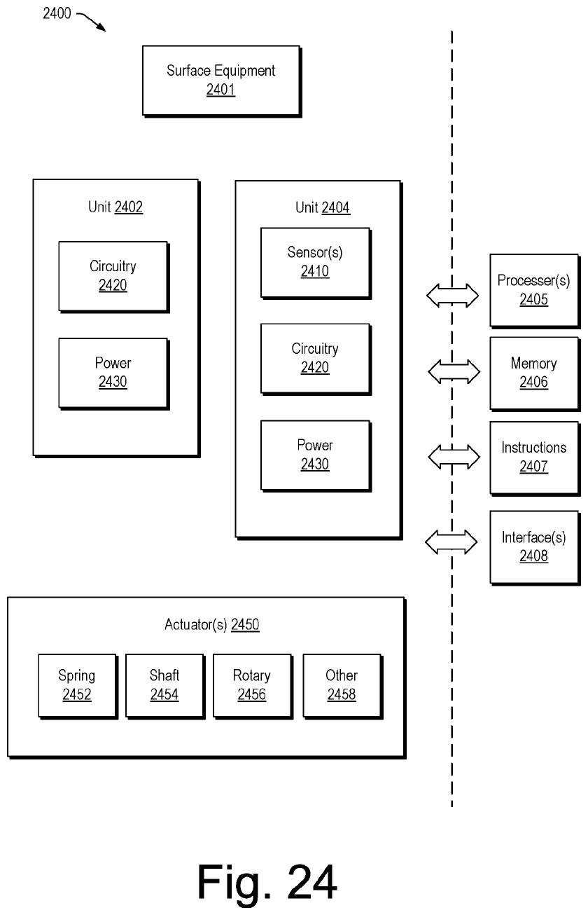

FIG. 24 shows an example of a system 2400 that includes surface equipment 2401, a unit 2402, a unit 2404, one or more processors 2405, memory 2406 accessible by at least one of the one or more processors 2405, instructions 2407 as may be stored in the memory 2406 where the instructions can include processor-executable instructions, one or more interfaces 2408 and one or more actuators 2450. As an example, the unit 2402 can include one or more of circuitry 2420 and one or more power sources 2430 (e.g., batteries, solar, wind, generator, grid, etc.). As an example, the unit 2404 can include one or more of one or more sensors 2410, circuitry 2420 and one or more power sources 2430 (e.g., batteries, solar, wind, generator, grid, etc.).

As an example, one or more components of the system 2400 can include a processor. As an example, one or more components of the system 2400 can include memory. As an example, one or more components of the system 2400 can include an interface. As an example, one or more components of the system 2400 can include a processor, memory accessible to the processor and processor-executable instructions stored in the memory that can be executed to control, for example, one or more of the actuators 2450. As an example, one or more of the actuator 2450 can include a unit or units such as the unit 2402 and/or the unit 2404.

As an example, a processor may be a microcontroller such as, for example, an ARM-based microcontroller, a RISC-based microcontroller, etc. As an example, a component can include a “system on a chip” (SoC). As an example, a gas lift valve can be a “smart” gas lift valve, a choke valve can be a “smart” choke valve, etc., where actuation for adjustment can be effectuated via one or more instructions, which may be generated locally, remotely or a combination of locally and remotely (see, e.g., the system 600 of FIG. 6).

As an example, a method can include receiving production fluid flow rate data from a well in a field that includes a plurality of wells; generating a gas lift profile for the well using the production fluid flow rate data; solving a system of equations representing at least two gas lift profiles for at least two of the plurality of wells to generate results; and issuing an instruction based at least in part on the results to control gas lift for production of fluid by the well. In such an example, the results may provide for optimal distribution of available lift gas.

As an example, a method can include solving a system of equations representing at least two gas lift profiles for at least two of the plurality of wells to generate results in a manner that is subject to one or more field constraints. In such an example, the solving may be subject to one or more local constraints that may be particular to one or more of the wells. For example, consider one or more of equipment and/or conditions types of constraints.

As an example, a method can include generating a gas lift profile at least in part by utilizing local perturbation around an incumbent, constraint-feasible operating point, where, for example, the local perturbation does not have a substantial effect on one or more other operating points of one or more other wells of the plurality of wells. For example, a local perturbation region for a well may be a region where changes do not have a substantial impact on one or more other wells in a common field that may be in fluid communication with a common reservoir and/or do not have a substantial impact on how available lift gas may be supplied to one or more other wells, which may be in fluid communication with a common reservoir.

As an example, a method can include generating a gas lift profile utilizing local sensitivity information. For example, consider local sensitivity information that is based on perturbation in a defined neighborhood of an existing operating point.

As an example, a method can include generating a gas lift profile at least in part by constructing a representative local approximating model in a trust region. In such an example, a trust region may be a region that is defined using one or more criteria, which may be specific to a well and/or with reference to one or more other wells that may utilize a common source of lift gas and/or that are in fluid communication with a common reservoir.

As an example, a gas lift profile can include a polynomial. As an example, a method can include generating a gas lift profile at least in part by utilizing a Taylor series expansion to generate a polynomial.

As an example, a system of equations can be a non-linear system of equations. As an example, non-linearity can increase where a method considers more than one well. For example, in going from a single well to multiple wells, a system can become increasing non-linear, which can demand increased computational resources. However, as an example, an approach may be extensible in that it can handle a number of wells that may be initially and/or increase to a relatively large number of wells (e.g., consider ten or more wells) where a solver can provide a robust solution in a reasonable amount of time that can be suitable considering fluid dynamics, control dynamics, etc. As mentioned, an increment may be utilized that accounts for equilibration after a change in an operating point such that another change is not too early in that it does not provide an opportunity for the change to physically affect a system. As explained, interrelationships may be via lift gas supply, reservoir dynamics, issuance of signals via a common solver resources, etc. Such interrelationships may be factors in determining a suitable increment size.

As an example, a method can include utilizing a waiting a period of time and repeating at least receiving, solving and issuing where the issuing issues at least one instruction for control of lift gas to one or more wells. In such an example, a method can include regulating the period of time based at least in part on production fluid flow rate data from one or more of the plurality of wells.

As an example, a method can include solving a system of equations by applying at least one field constraint and at least one well constraint for the well.

As an example, a method can include receiving data characterizing lift gas where, for example, solving of a system of equations can include utilizing at least a portion of the data characterizing the lift gas. In such an example, one or more operational points may be determined in a manner that depends on lift gas character, which may change dynamically over a span of time where gas lift is implemented to facilitate production from one or more wells in a field.

As an example, a method can include, responsive to a change in one or more conditions, repeating solving of a system equations where the solving includes utilizing a prior operating point fora well (e.g., or operating points for wells) and where the results include a new operating point for the well (e.g., or operating points for at least some of the wells). In such an example, the method can include repeating generating of one or more gas lift profiles for one or more wells based at least in part on the change to generate one or more new gas lift profiles where the repeating the solving includes utilizing the one or more new gas lift profiles.

As an example, a method can include issuing an instruction that can include an operating point instruction for a well. As an example, a method can include issuing a plurality of instructions for a plurality of wells to control gas lift operations in the plurality of wells where the instructions can be or include operating point instructions. As an example, a method can include receiving production fluid flow rate data for operation of a well at an operating point, waiting an equilibration increment, and repeating at least solving of a system of equations and issuing an instruction based at least in part on results of the solving.

As an example, a system can include one or more processors; memory accessible to at least one of the one or more processors; processor-executable instructions stored in the memory and executable to instruct the system to: receive production fluid flow rate data from a well in a field that includes a plurality of wells; generate a gas lift profile for the well using the production fluid flow rate data; solve a system of equations representing at least two gas lift profiles for at least two of the plurality of wells to generate results; and issue an instruction based at least in part on the results to control gas lift for production of fluid by the well.

As an example, one or more non-transitory computer-readable storage media can include computer-executable instructions executable to instruct a computing system to: receive production fluid flow rate data from a well in a field that includes a plurality of wells; generate a gas lift profile for the well using the production fluid flow rate data; solve a system of equations representing at least two gas lift profiles for at least two of the plurality of wells to generate results; and issue an instruction based at least in part on the results to control gas lift for production of fluid by the well.

As an example, a computer-implemented method for controlling or simulating gas lift in at least one production well can include maximizing an objective function for oil production in the at least one production well by i) constructing a model of oil production for a respective production well using local sensitivity information, ii) using the model to define the objective function, and iii) maximizing the objective function over a set of constraints using an interior point method to determine a new operating point for gas injection into a respective production well. In such an example, the interior point method may be configured to provide solution path feasibility where evaluated points are constraint feasible. As an example, a method can include repeating after a suitable period for stabilization (e.g., as to system dynamics, fluid dynamics, etc.).

As an example, a model can be based at least in part on real time input data, such as, for example, one or more of injection gas flow rate, oil production rate, and/or one or more additional variables based on a desired objective.

As an example, a method can include generating a new operating point that includes, for example, at least one set point for injection gas flow rate and/or at least one set point for one or more other control variables (e.g., if present, if desired, etc.).

As an example, a system for controlling gas lift in at least one production well can include a flow meter for measuring flow rate of oil produced from a respective production well as a function of time; and a controller, operably coupled to the flow meter, where the controller is configured to maximize an objective function for oil production in the at least one production well. In such an example, consider maximization via i) constructing a model of oil production for a respective production well using local sensitivity information, ii) using the model to define the objective function, iii) maximizing the objective function over a set of constraints using an interior point method to determine a new operating point for gas injection into a respective production well; and iv) using the new operating point to control gas injection into the respective production well.

As an example, a system can include a control valve for controlling flow rate of gas injected into a respective production well, where a new operating point includes at least one set point for the control vale to control the injection gas flow rate operating point of the respective production well. As an example, a controller may be selected from one or more of a local controller, an edge controller, or a cloud controller. As an example, a controller may be a hybrid controller that can include one or more local features and one or more remote features.

As an example, a computer program product can include computer-executable instructions to instruct a computing system to perform a method such as, for example, the method 700 of FIG. 7, etc.

As an example, a computer system may include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above can be implemented as computer program logic for use with a computer processor. Computer program logic may be embodied in one or more of various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. Computer instructions may be distributed in one or more forms, for example, as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web or public and/or private cloud, etc.).

As an example, a processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Various methods and processes described above may be implemented at least in part using one or more of such logic devices.

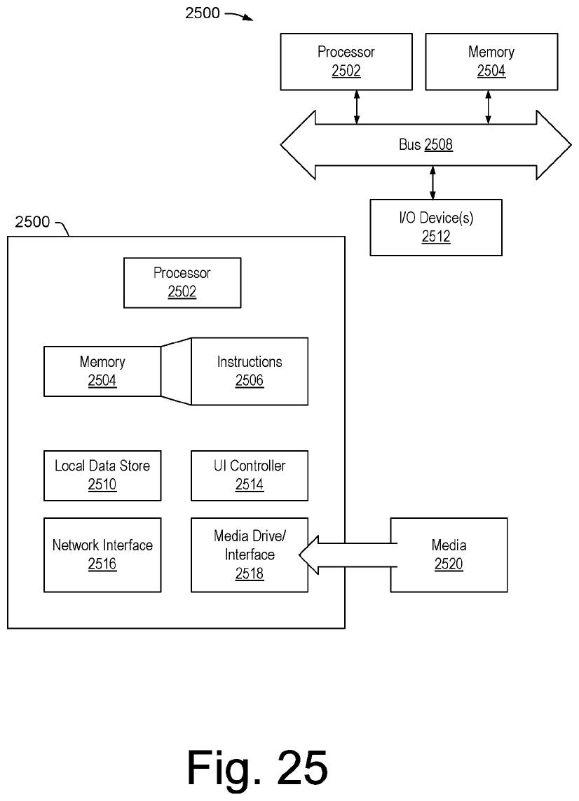

FIG. 25 illustrates an example device 2500, with a processor 2502 and memory 2504 that can be configured to implement various embodiments of methods, portions thereof, etc. The memory 2504 may also host one or more databases and can include one or more forms of volatile data storage media such as random-access memory (RAM), and/or one or more forms of nonvolatile storage media (such as read-only memory (ROM), flash memory, and so forth).

The device 2500 can also include a bus 2508 configured to allow various components and devices, such as the processors 2502, the memory 2504, and the local data storage 2510, among other components, to communicate with each other.

As an example, the bus 2508 can include one or more of various types of bus structures, including a memory bus or memory controller, a peripheral bus, an accelerated graphics port, and a processor or local bus using one or more of a variety of bus architectures. The bus 2508 can also include wired and/or wireless buses.

The local data storage 2510 can include fixed media (e.g., RAM, ROM, a fixed hard drive, etc.) as well as removable media (e.g., a flash memory drive, a removable hard drive, optical disks, magnetic disks, and so forth).

The one or more input/output (I/O) device(s) 2512 may also communicate via a user interface (UI) controller 2514, which may connect with I/O device(s) 2512 either directly or through the bus 2508. As an example, the network interface 2516 may communicate outside of the device 2500 via a connected network (e.g., wired and/or wireless).

A media drive/interface 2518 can accept removable tangible media 2520, such as flash drives, optical disks, removable hard drives, software products, etc. As an example, one or more sets of instructions of the instructions 2506 may reside on the removable media 2520 readable by the media drive/interface 2518.

In one possible embodiment, the input/output device(s) 2512 can allow a user to enter commands and information to the device 2500, and also allow information to be presented to the user and/or other components or devices. Examples of the input device(s) 2512 include, for example, sensors, a keyboard, a cursor control device (e.g., a mouse), a microphone, a scanner, and another input device. Examples of output devices can include one or more of a display device (e.g., a monitor or projector), speakers, a printer, a network card, etc.

### Conclusion

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving production fluid flow rate data from a well in a field that comprises a plurality of wells;
generating a gas lift profile for the well using the production fluid flow rate data;
solving a system of equations representing at least two gas lift profiles for at least two of the plurality of wells to generate results; and
issuing an instruction based at least in part on the results to control gas lift for production of fluid by the well.

2. The method of claim 1, wherein the results provide for optimal distribution of available lift gas.

3. The method of claim 1, wherein the solving is subject to one or more field constraints.

4. The method of claim 1, wherein the generating the gas lift profile comprises utilizing local perturbation around an incumbent, constraint-feasible operating point, wherein the local perturbation does not have a substantial effect on one or more other operating points of one or more other wells of the plurality of wells.

5. The method of claim 1, wherein the generating the gas lift profile comprises utilizing local sensitivity information.

6. The method of claim 5, wherein the local sensitivity information is based on perturbation in a defined neighborhood of an existing operating point.

7. The method of claim 1, wherein the generating the gas lift profile comprises constructing a representative local approximating model in a trust region.

8. The method of claim 1, wherein the gas lift profile comprises a polynomial.

9. The method of claim 8, wherein the generating the gas lift profile comprises utilizing a Taylor series expansion to generate the polynomial.

10. The method of claim 1, wherein the system of equations comprises a non-linear system of equations.

11. The method of claim 1, comprising waiting a period of time and repeating at least the receiving, the solving and the issuing.

12. The method of claim 11, comprising regulating the period of time based at least in part on production fluid flow rate data from one or more of the plurality of wells.

13. The method of claim 1, wherein the solving comprises applying at least one field constraint and at least one well constraint for the well.

14. The method of claim 1, comprising receiving data characterizing lift gas wherein the solving comprises utilizing at least a portion of the data characterizing the lift gas.

15. The method of claim 1, comprising, responsive to a change in one or more conditions, repeating the solving wherein the solving comprises utilizing a prior operating point for the well and wherein the results comprise a new operating point for the well.

16. The method of claim 15, comprising repeating the generating the gas lift profile for the well based at least in part on the change to generate a new gas lift profile wherein the repeating the solving comprises utilizing the new gas lift profile.

17. The method of claim 1, wherein the instruction comprises an operating point instruction for the well.

18. The method of claim 17, comprising receiving production fluid flow rate data for operation of the well at the operating point, waiting an equilibration increment, and repeating at least the solving and the issuing.

19. A system comprising:
one or more processors;
memory accessible to at least one of the one or more processors;
processor-executable instructions stored in the memory and executable to instruct the system to:
receive production fluid flow rate data from a well in a field that comprises a plurality of wells;
generate a gas lift profile for the well using the production fluid flow rate data;
solve a system of equations representing at least two gas lift profiles for at least two of the plurality of wells to generate results; and
issue an instruction based at least in part on the results to control gas lift for production of fluid by the well.

20. One or more non-transitory computer-readable storage media comprising computer-executable instructions executable to instruct a computing system to:
receive production fluid flow rate data from a well in a field that comprises a plurality of wells;
generate a gas lift profile for the well using the production fluid flow rate data;
solve a system of equations representing at least two gas lift profiles for at least two of the plurality of wells to generate results; and
issue an instruction based at least in part on the results to control gas lift for production of fluid by the well.
